(19) United States
(12) Patent Application Publication
(10) Pub. No.: US 2017/0245540 A1
(43) Pub. Date: Aug. 31, 2017

(54) PRODUCE PREPARATION

(71) Applicant: FAL-ROSS LIMITED, Auckland (NZ)

(72) Inventors: Edward Dean MCLEAN, Waiuku (NZ); Kelvin Johan HOLM, Auckland (NZ); Kendall James BRISTOW, Auckland (NZ)

(73) Assignee: FAL-ROSS LIMITED, Auckland (NZ)

(21) Appl. No.: 15/507,289

(22) PCT Filed: Aug. 31, 2015
(86) PCT No.: PCT/IB2015/056585

§ 371 Date: Feb. 28, 2017

(30) Foreign Application Priority Data
Aug. 29, 2014 (NZ) 629749
May 13, 2015 (NZ) 708060

(51) Int. Cl. A23N 7/02; A23N 4/12; A23N 7/08; B26D 1/147; B26F 1/24; B26D 5/00; B26D 5/08; B26D 7/06; B26D 7/32; B26D 7/01; A23N 3/00; B26D 3/26

(52) U.S. Cl. CPC A23N 7/026; A23N 3/00; A23N 4/12; A23N 7/08; B26D 1/147; B26D 3/26; B26D 5/007; B26D 5/08; B26D 7/0625; B26D 7/32; B26D 7/01; B26F 1/24; B26D 2007/011; B26D 2210/02

(57) ABSTRACT

It is a system for processing produce comprising a plurality of freestanding pucks for carrying items of produce, each puck comprising a base and a spike extending from the base, the spike configured to pierce an item of produce and hold the item in a substantially fixed position relative to the base.

### FIELD OF THE INVENTION

The present invention relates to apparatus and methods for preparing produce such as fruits and vegetables.

In particular, the present invention relates to the bulk processing of whole produce for subsequent consumption, and/or for further processing.

### BACKGROUND TO THE INVENTION

Apparatus and methods for automated and/or bulk processing of fruits and vegetables are well known. These processes include washing, sorting, peeling, coring, slicing, dicing, etc., of fresh produce to prepare the produce for direct consumption (e.g., convenient sliced and pre-washed fruit packets), or for further processing, e.g. freezing, canning, drying, and cooking.

There is a need for continual improvement of the processing apparatus and methods, in particular to increase efficiency, while also reducing wastage and damage to the produce being processed.

The need for reducing damage to the produce is especially important where the end product is for fresh consumption (ready-to-eat “fresh cut” products), since the appearance of bruises and excess browning or oxidation of the produce reduces visual appeal.

Additionally, processing methods for such “fresh cut” products are ideally more accurate and consistent than prior art systems. For example, it may be desirable to have slices/pieces which are of a consistent size and shape for visual appeal and quality control.

Additionally, conventional processing systems are typically designed for a specific type of fruit or vegetable. Once set up, there is no or little ability to retrofit or customise the equipment to suit other types of produce, or to modify the equipment to change or add processing steps for different requirements.

Accordingly, it is an object of the present invention to provide improved apparatus and methods for processing produce, which address some disadvantages of the prior art as discussed.

It is an additional or alternative object of the present invention to provide improved apparatus and methods of produce preparation which are adaptable for different types of produce and/or for different processing requirements.

It is an additional or alternative object of the present invention to provide the public with a useful choice.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY OF THE INVENTION

According to an aspect the invention broadly comprises apparatus for processing produce comprising:
a plurality of freestanding pucks for carrying items of produce, each puck comprising a base and a spike extending from the base,
an actuator configured to pierce an item of produce with said spike and hold the item in a substantially fixed position relative to the base.

According to a further aspect the piercing is along a natural axis of the item of produce.

According to a further aspect the spike is fluted along at least a majority of the length of the spike.

According to a further aspect the spike is tapered towards a tip of the spike, and said taper extends substantially the entire length of the spike.

According to a further aspect the base of the puck is substantially circular in plan view.

According to a further aspect the base of the puck comprises a top face from which the spike extends, a bottom face, and one or more side faces extending between the top face and the bottom face.

According to a further aspect the spike extends substantially perpendicular to the top face from a central portion of the top face.

According to a further aspect the central portion of the top face is concave.

According to a further aspect the top face comprises a cutting relief sized to accommodate a core tube.

According to a further aspect the cutting relief is one of a slot or a recess.

According to a further aspect the invention broadly comprises a puck as described in any one of the preceding clauses.

According to a further aspect the puck includes one or more registration features.

According to a further aspect the freestanding pucks are loaded onto the system via a carousel conveyor.

According to a further aspect the apparatus further comprising at least one blade for performing at least one reduction operation on said produce.

According to a further aspect each item of produce remains on a single puck throughout the processing.

According to a further aspect the puck further comprises one or more identification features.

According to a further aspect the base of the puck further comprises one or more registration features.

According to a further aspect the one or more registration features comprise(s) positional indicators associated or associable with one or more parts of the item of produce on the puck.

According to another aspect the invention broadly comprises a method of processing produce comprising:
taking an item of produce,
assigning said item of produce to an individual puck including a spike extending therefrom, by piercing said produce on said spike.

According to a further aspect the method further comprising:
performing at least one further operation on said pierced produce, said operation reducing said produce.

According to a further aspect said puck is as claimed in claim 11.

According to a further aspect said produce is positioned on said spike such that a predetermined feature of said produce is aligned to a predetermined position relative to said puck.

According to another aspect the invention broadly comprises a system comprising apparatus for detecting one or more anatomical features of an item of produce via a pair of cameras aligned on common axis, and
using said anatomical features to determine a natural axis of said produce.

According to a further aspect the anatomical feature is one of a stem, calyx, blossom end, pedicel, tip, root of the produce.

According to a further aspect the system further comprising apparatus for aligning said axis of the item of produce along a predetermined direction and at a predetermined position, such that the approximate location of a centroid of the item of produce is predicted.

According to a further aspect the system is further configured to pierce the item of produce such that the centroid is at a predetermined location.

According to a further aspect the system further comprising apparatus for sequentially rotating the item of produce about two substantially orthogonal axes, until said axis is aligned along a predetermined direction.

According to a further aspect the system further comprising apparatus for translating the item of produce, until said axis is aligned along a predetermined direction. The According to a further aspect the system further comprising a pair of grippers configured to grip the item of produce on two substantially opposite faces of the item, the grippers synchronously actuable to rotate the item of produce about an axis perpendicular to said opposite faces, and/or translate the item of produce.

According to another aspect the invention broadly comprises apparatus for slicing produce comprising:
two blade columns extending adjacent each other, each column rotatable about a longitudinal axis of the column, and
means for moving produce between the two columns,
wherein each column comprises at least one blade having at least one cutting region,
wherein rotation of the blade(s) in each column is synchronised with movement of produce between the columns.

According to a further aspect rotation of the blades are synchronised with movement of the produce such that a linear velocity of said produce is equal to a tangential velocity of the blades at a blade tip.

According to a further aspect each blade column comprises a plurality of disc blades spaced apart from each other along the longitudinal axis of the column, each disc blade aligned substantially co-planar with an associated disc blade in the other blade column.

According to a further aspect each blade comprises at least one cut-out region at the periphery of the blade, configured to accommodate a core region of the produce, and wherein the centre of the cut-out defines the centre of the cutting region.

According to a further aspect each cut-out region is substantially semi-circular in shape.

According to a further aspect each blade comprises a plurality of cut-out regions substantially equally spaced apart from each other.

According to a further aspect every second cut-out along the periphery of the blade is covered in use by a housing of the blade column.

According to a further aspect each item of produce is held on a puck as the produce is moved between the two blade columns.

According to a further aspect a housing portion of one or both blade column(s) keys with the puck as the puck is conveyed between the two blade columns.

According to a further aspect a drive belt of the conveyor system simultaneously drives rotation of the blade columns.

According to a further aspect each blade column comprises a plurality of blades spaced radially with respect to the longitudinal axis of the column.

According to a further aspect each blade column is synchronised so that the blade positions of each blade stack are mirrored about a central plane.

According to a further aspect the blades are synchronised to align with a central axis of produce passing in them.

According to a further aspect the blades are synchronised to be offset with a central axis of produce passing in them.

According to a further aspect said offset is such that said blades pass in front of said central axis.

According to a further aspect said offset is such that said blades pass in behind of said central axis.

According to another aspect the invention broadly comprises a method of processing whole (or substantially whole) produce comprising:
passing a hollow core tube through said produce along a path substantially coaxial with a core axis of said produce,
separating a core separated from said produce by said core tube, leaving a hollow passage through said produce,
partially removing said core tube from said produce,
inserting a blade into said hollow passage, and sweeping said blade along a radially expanding pathway, and
removing said blade.

According to a further aspect said method further comprises:
sweeping said blade at least one full revolution, with said blade in a radially fixed position, prior to removing said blade.

According to a further aspect said blade is curved such that said sweeping of said blade traces an approximately spherical volume.

According to a further aspect said blade pivots outwardly about pivot point within a radially oriented plane.

According to a further aspect said blade translates radially outwardly.

According to a further aspect said blade is actuated pneumatically.

According to a further aspect said core tube remains engaged in said hollow passage at a first end of said produce, and a least one member pierces said produce at a second end of said produce, such that said produce is supported at opposing ends.

According to a further aspect said at least one member is a slicing blade, that partially slices said produce.

According to another aspect the invention broadly comprises apparatus for performing the method the previous clauses.

According to another aspect the invention broadly comprises a method of processing produce comprising:
piercing said produce along a natural axis of the produce, on a spike mounted on a puck,
rotating said puck substantially about an axis of said spike,
pressing a peeling blade against an outer surface of said produce at a substantially tangential location, while said produce is being rotated, such that said surface passes said blade at a substantially tangential speed, moving said peeling blade along the surface of said produce in a direction substantially at right angles to said tangential speed.

According to a further aspect said blade is pressed against said surface of said produce at a substantially constant pressure.

According to a further aspect said produce is rotated at a variable speed such that the tangential speed of the produce surface passed said blade is substantially constant.

According to a further aspect said movement of said peeling blade along said surface is via a rotation of said peeling blade.

According to another aspect the invention broadly comprises apparatus for performing the method according to the previous clauses.

According to another aspect the invention broadly comprises apparatus for removing spike mounted produce comprising:
passing said spike mounted produce past at least one inclined ramp member, such that a tip of said ramp member engages a lower portion of said spike mounted produce, and said produce is moved axially along said spike as said produce moves past said ramp.

According to another aspect a pair of said ramp members are provided either side of said spike and separated by a slot, and wherein each of said ramp members engage a respective side of said produce.

According to another aspect said apparatus further comprises a conveyor for moving said spike mounted produce past said ramp.

According to another aspect said apparatus further comprises a means for catching said produce as it is removed from said spike.

According to another aspect the invention broadly comprises a method of processing produce substantially as herein described and with reference to any one or more of the accompanying drawings.

According to another aspect the invention broadly comprises a method of processing produce substantially as herein described and with reference to any one or more of FIGS. 12 to 15.

According to another aspect the invention broadly comprises apparatus for processing produce substantially as herein described and with reference to any one or more of FIGS. 12 to 15.

According to another aspect the invention broadly comprises a method of processing produce substantially as herein described and with reference to any one or more of FIGS. 16 to 18.

According to another aspect the invention broadly comprises apparatus for processing produce substantially as herein described and with reference to any one or more of FIGS. 16 to 18.

According to another aspect the invention broadly comprises a system for processing produce substantially as herein described, with reference to any one or more of the accompanying drawings.

According to another aspect the invention broadly comprises apparatus for processing produce substantially as herein described, with reference to any one or more of the accompanying drawings.

According to another aspect the invention broadly comprises apparatus for slicing produce substantially as herein described, with reference to any one or more of the accompanying drawings.

According to another aspect the invention broadly comprises a puck for carrying an item of produce substantially as herein described, with reference to any one or more of the accompanying drawings.

According to another aspect the invention broadly comprises a method of processing produce substantially as herein described and with reference to any one or more of FIGS. 19 to 22.

According to another aspect the invention broadly comprises apparatus for processing produce substantially as herein described and with reference to any one or more of FIGS. 19 to 22.

According to another aspect the invention broadly comprises a method of processing produce substantially as herein described and with reference to any one or more of FIGS. 23 to 25.

According to another aspect the invention broadly comprises apparatus for processing produce substantially as herein described and with reference to any one or more of FIGS. 23 to 25.

According to another aspect the invention broadly comprises a method of processing produce substantially as herein described and with reference to any one or more of FIGS. 26 to 27.

According to another aspect the invention broadly comprises apparatus for processing produce substantially as herein described and with reference to any one or more of FIGS. 26 to 27.

The term “produce” includes any fruit or vegetable, or other produce where an additional reduction process is desirable before eating. For example, the presently described system is particularly suited to whole produce, or near whole produce, wherein it is desirable reduce the produce in some way.

A non-exhaustive list of examples of produce may include: apples, oranges, pineapple, peers, plums, peaches, kiwifruit, lemons, limes, pomegranate, and onions etc.

The presently described system is particularly suited to produce that can be spiked along a convenient axis. For example, the axis may be an axis along which the core of the produce (if present) is aligned, and/or about which the produce is generally symmetrical.

The produce may include elements that make it difficult to spike the produce along a large length of the axis, for example a stone fruit. For such embodiments, it is anticipated that a shorter spike can be employed, and may optionally further benefit from additional exterior stabilisation, which may, or may not, involve an additional spike.

The term “puck” refers to a carrier for stabilising produce on, as it travels through the processing line (and through processes such as identifying, orienting, peeling, slicing, coring, etc). The term “puck” as used as a convenient identifier and is not necessarily restricted to any particular shape. For example, a puck may not be generally disc shaped.

“Fresh cut” refers to produce that have been processed e.g., by peeling, slicing, chopping, coring, with or without washing or other treatment, prior to being packaged for use by the consumer or a retail establishment. Fresh-cut produce is typically “ready-to-eat”, and does not normally require additional preparation, processing, or cooking before consumption.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples only.

### BRIEF DESCRIPTION OF THE DRAWINGS

Preferred configurations will be described by way of example only and with reference to the drawings, in which:

FIG. 1 is a schematic flow diagram showing preferred operations of the produce preparation process,

FIG. 2 is a partial view of one preferred configuration of the processing equipment, showing details of the flume and loading zone,

FIGS. 3a to 3d are schematic side views showing a preferred sequence of loading the produce from the flume to the orientation module,

FIGS. 4a to 4e are side elevation views of the orientation module, showing various steps of the orientation process,

FIG. 5 is a partial view of the processing equipment of FIG. 2 from another angle (flume not shown), showing details of the spiking unit,

FIGS. 6a and 6b show detailed views of the puck and puck assembly (with apple attached) respectively,

FIG. 7 shows one preferred embodiment of the chunking station,

FIGS. 8a to 8e are schematic plan views of the chunking blades and apple, showing the sequence of movement of the blades and apple through the cutting process,

FIG. 9 shows a detailed view of one preferred embodiment of chunking blades in isolation, and

FIG. 10 shows one preferred embodiment of a corer-slicer carousel,

FIG. 11 is a schematic of one embodiment detailing a preferred operation performed at each station,

FIG. 12 is a perspective view of an alternative embodiment including a corer blade.

FIG. 13 is a simplified perspective cutaway view of a preferred corer mechanism of FIG. 12.

FIG. 14 is a simplified perspective cutaway view of a preferred corer mechanism of FIG. 12, in operation.

FIG. 15 is a perspective view of the apparatus of FIG. 12 showing the corer blade and apple after the coring operation is complete.

FIG. 16 is a perspective view of an alternative corer-slicer station showing an alternative corer mechanism.

FIG. 17 is a close up perspective view of the alternative corer mechanism of FIG. 16, showing the corer blade retracted.

FIG. 18 is a close up perspective view of the alternative corer mechanism of FIG. 16, showing the corer blade extended.

FIG. 19 is a perspective view of a peeling station according to one preferred configuration.

FIG. 20 is a perspective view of the peeling station of FIG. 19, shown with an apple present.

FIG. 21 is a perspective view of the peeling station of FIG. 20, shown with the peeling head in a different position.

FIG. 22 is a perspective view of the peeling station of FIG. 20, shown with the peeling head in a still different position.

FIG. 23 is a plan view of a core removal station.

FIG. 24 is a plan view of a core removal station, showing an alternative blade position.

FIG. 25 is a plan view of a core removal station, showing a still alternative blade position.

FIG. 26 is a perspective view of the core removal station of FIG. 23.

FIG. 27 is a stripped down view of the core removal station of FIG. 26 showing the ramp and puck relative positioning.

### DETAILED DESCRIPTION OF PREFERRED EMBODIMENTS

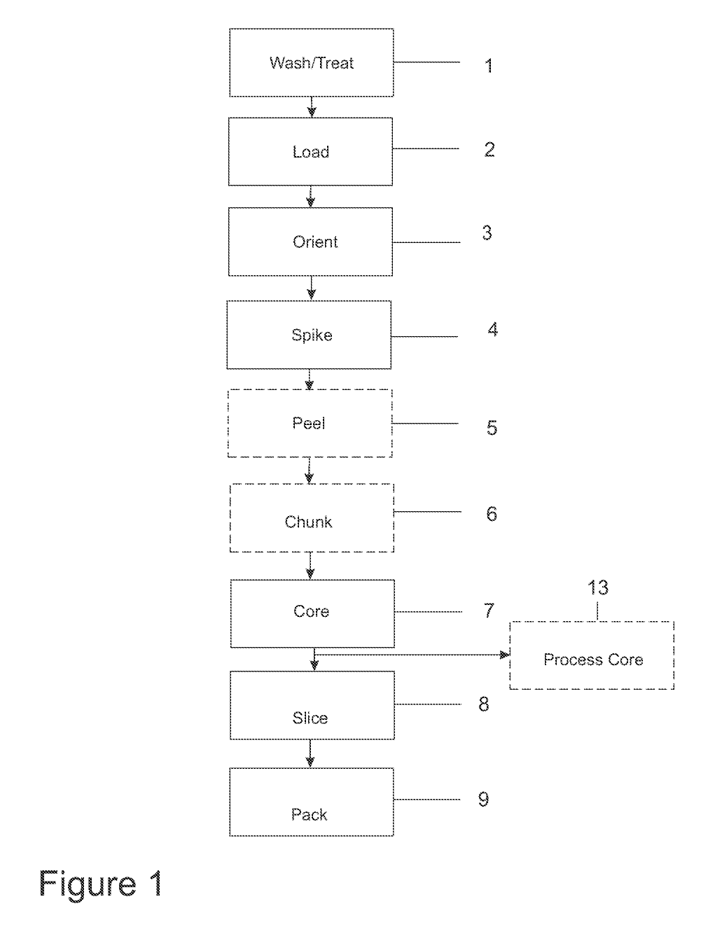

FIG. 1 shows the main steps of an exemplary produce preparation process. It should be understood that these steps may be eliminated or replaced as required, and that additional steps may be added as required.

For example, if peeling is required, a peeling apparatus/station 5 may be added (for example as described later). Similarly, a chunking station 6, may be added if the produce is intended to be cut into pieces/chunks, prior to packing at a packing station 9.

As will be described in more detail below, the puck conveyor system of the present invention facilitates scaling and modification of the process as required.

Additionally, the order of the steps is not necessarily restricted to that shown in FIG. 1. It should be understood that, while a certain step would logically need to precede another, the order to the sequence may generally be adapted to suit the specific application as required.

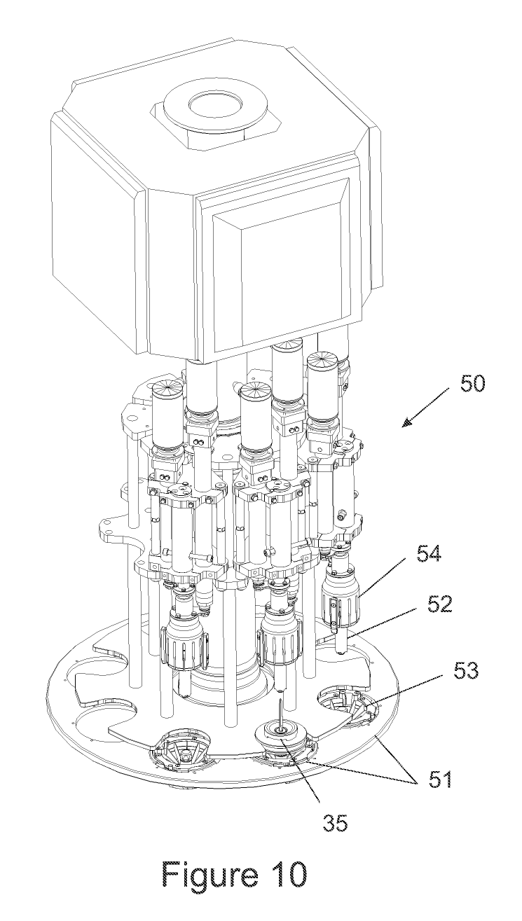

The reference to “stations”, “modules”, “zones”, etc., is used to conveniently refer to separate steps of the process and does not necessarily require a physical location which is separate from the previous (or subsequent) station. For example, the coring and slicing units may be located on the same piece of equipment, as shown in FIG. 10.

Additionally, for brevity, the following description will refer primarily to apples as the type of produce being processed. However, it should be understood that the apparatus and methods of the present invention may be used to prepare other types of produce such as fruits or vegetables. An Apple has been used to describe only one example, for convenience.

### Conveying/Loading

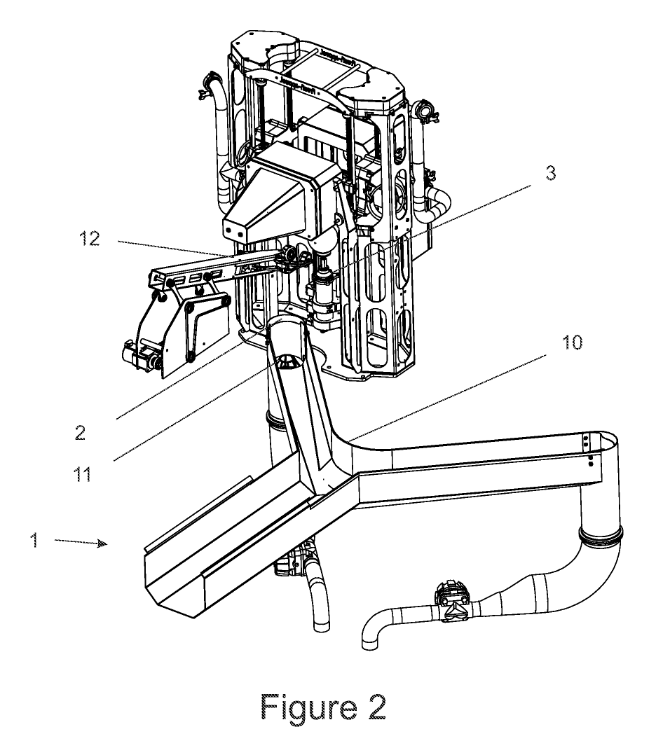

As shown in FIG. 1, the apples are conveyed from an input, washing and/or pre-treatment station 1 to a loading zone/station 2. In one configuration, the conveying system is a flume or liquid conveyor 10, as shown in FIG. 2.

Washing and/or pre-treatment may occur or may continue within the flume 10. Examples of pre-treatment include treatment of the liquid medium with UV or soaking of the produce in antioxidant, such as disclosed applicant's U.S. Pat. No. 7,217,358.

Alternatively, produce may be delivered to loading station 2 via a material conveyor rather than a flume. At least one reason for preferring a material conveyor over a flume, is that not all produce will float.

Optionally, the produce may be pre-sorted along the flume 10 (or conveyor) into diverging streams. For example, the produce may be sorted according to size or weight, or a defect detection system may operate as the produce is moved along the flume (or conveyor), to remove defective items at this early stage.

With reference to FIG. 2, at or towards the end of the flume 10 is loading zone 2, preferably comprising a lift cage 11 and transfer arm 12. The lift cage 11 is configured to stabilise and lift individual apples from the flume 10. Once lifted to a predetermined height, the transfer arm 12 grips the presented apple 100 and transports it to base support 20 of orientation module 3.

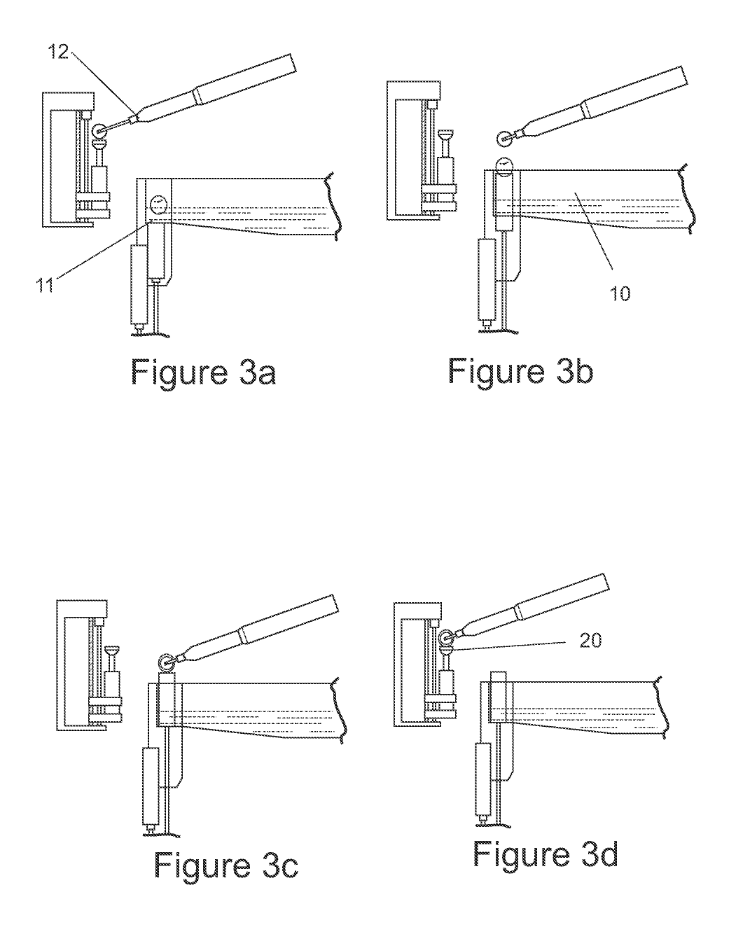

As shown in FIGS. 3a to 3d, transfer arm 12 is an articulated device able to grip and transfer the produce from the lift cage in the flume 10 (or conveyor). Optionally, the gripper element on transfer arm 12 may also measure or provide an estimation of the size of the produce while transferring the produce to the orientation module. This can be achieved for example by using displacement information available from the actuation transducer and relating it to the distance between the gripper fingers.

In one embodiment, the lift cage 11 only moves vertically, and the transfer arm 12 only effects translational movement of the apple onto the orientation module. This is shown in the sequence of side views 3a to 3d.

In another embodiment, the lift cage 11 and/or the transfer arm 12 also rotates the fruit. This may increase efficiency of the subsequent orientation process, especially in the case of non-symmetrical fruits which tend to float in certain orientations. Pears, for example, predominantly float either stem up or stem down.

It may be preferable that a predetermined rotation of each pear is applied so that the stem is not aligned vertically in order to help speed up the subsequent orientation step (described in more detail below).

### Vision/Orientation Module

The primary purpose of the orientation module 3 is to orient the produce, based on specific anatomical features, into a predetermined alignment for subsequent spiking onto puck 31 (described in more detail below).

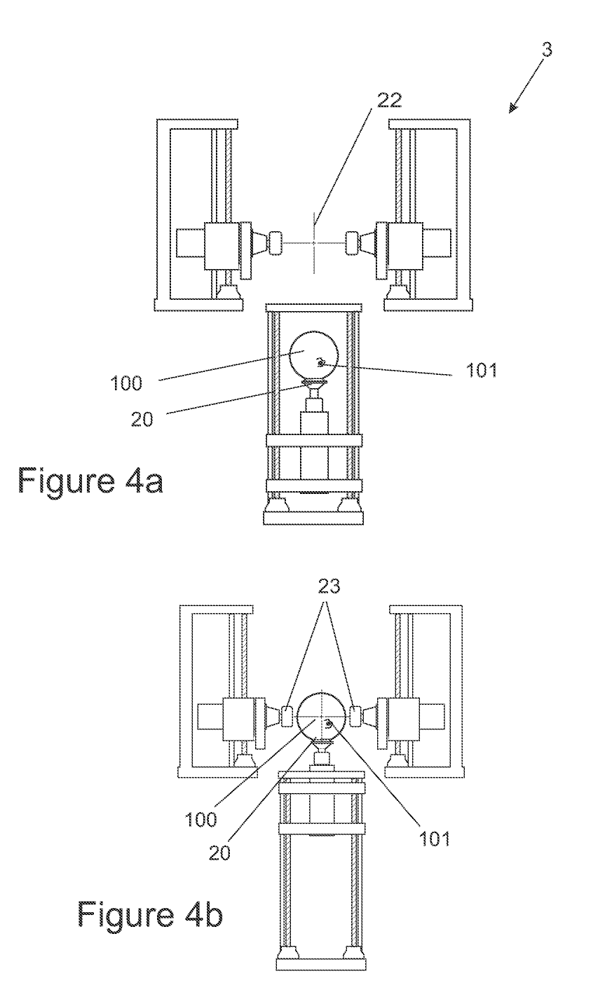

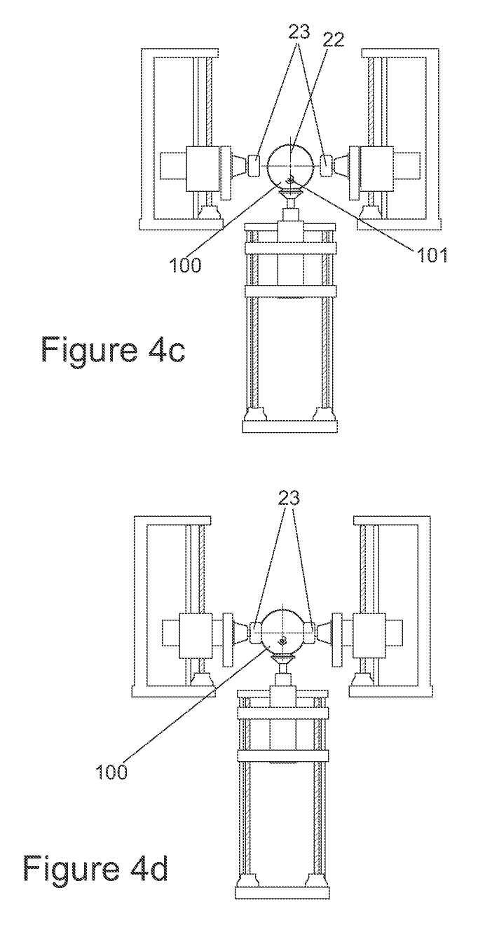

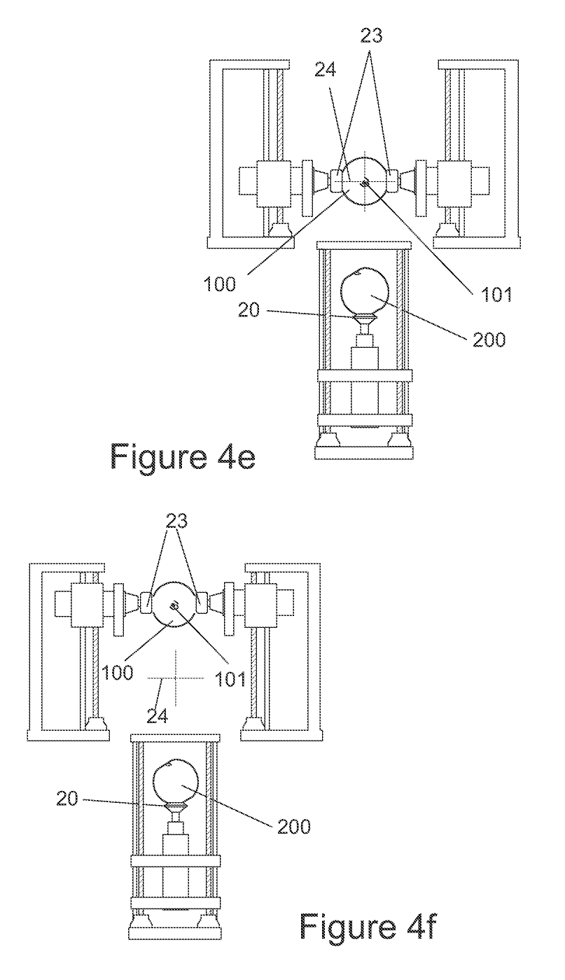

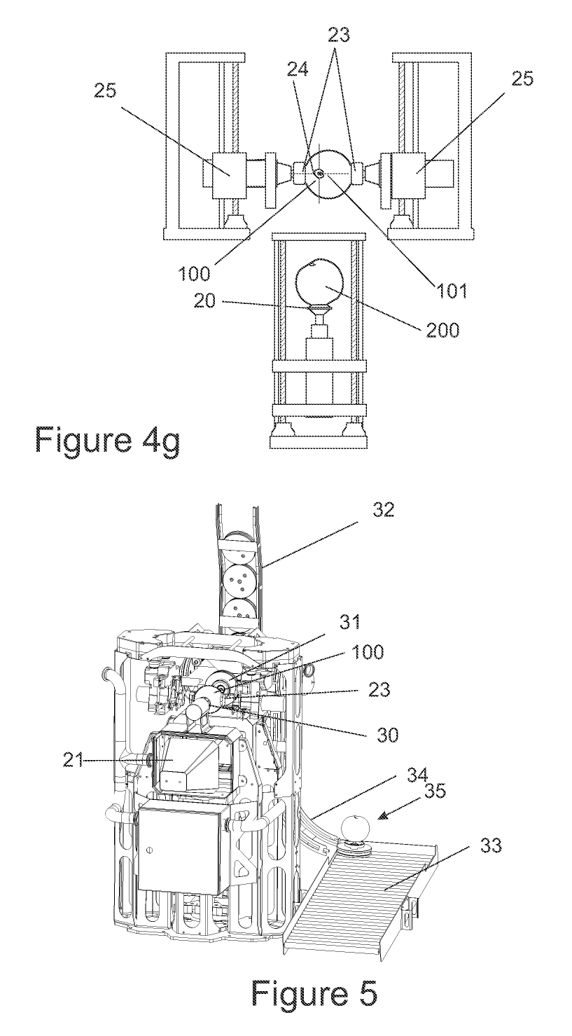

With reference to FIG. 4a, the apple 100 has been transferred to the base support 20 of the orientation module 3. As shown in this figure, the stem is pointing downwards and slightly to the right hand side.

At approximately the opposite surface of the apple will be positioned the calyx. A natural axis typically exists on which lie the stem, calyx and approximate centroid of the apple. It will be appreciated that the natural variation in individual fruit anatomy, will mean that the axis may need to be estimated/approximated in order to provide a ‘best fit’ line through the outwardly observable features of the stem and calyx.

With reference to FIG. 4b, base support 20 is raised to a position such that the apple is within the field of view of cameras 21 (not shown). In this case, the apple is symmetrical and the midpoint of the apple is substantially aligned with the cameras axis (denoted by the crosshairs). The camera is preferably provide a visual recognition system to allow this alignment to occur.

Once the apple 100 is in the visual field of the camera system, it can be moved around to allow the cameras to detect predetermined anatomical features 101 of the apple. It may be preferable to move the apple 100 about more than one rotational degree of freedom and or translational degree of freedom in order to accurately identifying a preferred natural axis.

In the preferred apparatus, a pair of coaxially aligned cameras are provided. With reference to FIG. 4 a-g, the cameras are aligned so that one is looking into the plane of the page, while the other is looking out of the plane of the page. Accordingly, one camera can see the stem region of the apple 100, while the other can see the calyx region.

As shown in FIG. 4b-c, the base support 20 is able to rotate the apple 100 about a vertical axis. In FIG. 4c, the apple 100 has been rotated and the stem 101 is aligned with vertical crosshair 22, and is pointing slightly downwards.

Examples of anatomical features that may be detected include the stem or calyx regions of pomaceous fruits such as apples and pears, the stem end or suture of stone fruit, the pedicel of citrus fruits, the stem or tips of carrots, and the root region or stem of onions. These anatomical markers preferably indicate one end of a “longitudinal” axis of the fruit or vegetable. Alternatively, the anatomical marker may be any predetermined feature that can assist with identifying an axis of the fruit. For example, the suture of stone fruit can indicate the general direction of an “axis”.

This axis is typically the axis along which the core (if present) is aligned, and about which the fruit or vegetable is generally symmetrical. In the preferred embodiment, the fruit or vegetable will subsequently be spiked substantially along this longitudinal axis (discussed in more detail below).

As discussed above, the apple is rotated on the base support 20 about a substantially vertical axis until the stem or calyx 101 is detected to be aligned with a central vertical axis (shown schematically as 22) in the captured image, as shown in FIG. 4c. If the produce has two distinct anatomical features (such as a stem and calyx) indicating two points on the “longitudinal axis”, there may be two cameras positioned substantially opposite each other to capture and align each feature.

Alternatively, a single moving camera may be used to locate these features as the produce 100 is rotated by known amounts. Appropriate software algorithms can then be utilised to align the natural produce axis with a predetermined direction.

In the instance that the apparatus is intended to process produce, having only one anatomical marker, one of the cameras may be un-used. It is envisaged that the systems controlling software can be adapted to use various algorithms appropriate for the type of produce being processed at the time.

With reference to FIG. 4d, rotating grippers 23 are actuated to move inwards and grip the apple 100. In one preferred configuration, two grippers 23 move substantially horizontally to grip the apple on two opposite faces, as shown in FIG. 4d. In the illustrated example, due to the preceding rotation of apple 100 on base support 20, the grippers 23 do not contact the stem or calyx of the apple, and therefore do not interfere with subsequent motion of the spike in piercing the apple through its stem- and calyx axis (described in more detail below).

The grippers 23 are then rotated synchronously, to rotate the apple about a substantially horizontal axis and align the anatomical feature (e.g., stem or calyx 101) with a central horizontal axis (shown schematically as 24) in the captured image, as shown in FIG. 4e.

At this point, the “natural axis” (specifically, the stem-and-calyx axis of the apple 100) is known, and positioned so that it aligns with a predetermined vector (illustrated by the crosshairs which represent a line extending normal to the page).

In the meantime, a second apple 200 may be positioned onto base support 20, and the same orientation process initiated on the second apple.

In the preferred arrangement, to facilitate continuous processing and to maximise the around each of the sequentially occurring operations, the following operations occur along three substantially orthogonal directions: input of produce, gripping of produce and viewing of produce.

Specifically, in the preferred embodiment, the base support 20 is lowered when receiving the produce, and raised to bring it into the camera's field of view, such that input of the produce is along a substantially vertical axis (first direction). The camera is positioned such that its optical axis is substantially about a horizontal axis (second direction). The grippers grip the produce about another horizontal axis which is substantially orthogonal to the first and second directions. In this way, these elements do not interfere with each other, allowing continuous loading, vision and orientation of the produce.

Base support 20 and grippers 23 are preferably controlled by servomotors (not shown), in response to signals from the camera 21, and associated recognition software. Grippers 23 may be programmed to predict or measure (via the captured image, or measurement of the displacement of the gripper transducers) the size of the produce, and change the gripping force accordingly with reference to the produce size data.

As a result of rotation about two axes, the specified anatomical features 101 of apple 100 are preferably aligned substantially at the centre of the captured image (i.e. with the crosshairs). The natural axis 102 of the apple 100 is therefore fixed along this position. In the case of apples, this natural axis 102 is generally the stem-calyx axis.

For other types of produce, such as citrus fruits, this axis may be the central column of the fruit. For bulbs such as onions, this axis may be the stem-root axis of the bulb. Importantly, the produce will be spiked along this axis 102 in the subsequent spiking step 4. It should be appreciated that the final aligned position of the produce may be modified depending on the axis of movement of the spike.

The orientation steps described above relate to one preferred embodiment of the system. However, it should be appreciated that other apparatus and various control systems may be used to perform the same alignment function, i.e., the orientation module 3 orients the item of produce into a specific alignment by detecting predetermined anatomical features of the item.

For example, in an alternative embodiment, produce may be rotated about the horizontal axis prior to rotation about the vertical axis. This may be the case if transfer arm 12 also functions as rotating grippers 23, so that a separate pair of grippers is not required. However, as discussed previously, it is preferable that the stem-and-calyx axis is first aligned to be substantially perpendicular to the direction of movement of the grippers 23 so that the grippers do not cover up the stem-and-calyx axis, to allow subsequent piercing of the apple along this stem-and-calyx axis.

It is envisaged that various possible conditions are predicted and accommodated by the control program. For example, if the apple 100 is presented on the base support 20 with its stem-calyx axis substantially vertical, such that the stem or calyx 101 cannot be detected by the camera 21 upon rotation of the base support, the system may assume that the apple is in this alignment. Orientation then proceeds by actuating the rotating grippers 23, to rotate the apple 100 about the horizontal axis first. The grippers 23 may then release the produce 100 back onto the base support 24 rotation about a vertical axis.

Alternatively, in order to detect such conditions, multiple cameras may be positioned at various positions to capture images along multiple planes. Additionally or alternatively, when processing non-symmetrical items such as pears which float either stem up or stem down (as described above), a preset rotation of each pear during loading onto the base support may be included so that the stem is not aligned vertically, and may therefore be detected during rotation about the vertical axis, as described in the preferred embodiment.

Additionally or alternatively, the camera 21 may also be used to identify defective items to be rejected at this stage. Optionally, the camera may also identify and store data about other features of the produce, e.g. size, diameter, so that the data may be used in subsequent processes, or for quality control.

With reference to FIG. 4f, the apple 100 (which is in a known alignment) is lifted upwards into a position ready to be spiked as described later.

With further reference to FIG. 4g, a potential additional step in which the apple 100 needs to be shifted laterally due to the stem/calyx axis being off centre of the apple 100, is illustrated.

As shown on this figure, the apple 100 has a natural axis that is off centre, and therefore the grippers 23 have laterally shifted the produce 100 to the right, in order to achieve alignment with the desired direction (represented by the crosshairs).

It will be appreciated that produce will frequently not be perfectly symmetrical, and therefore lateral movement may be necessary, in order to align the natural axis of the produce with the desired vector. In the illustrated configuration, grippers 23 are operated by actuators 25. These actuators 25 are synchronously translated to maintain a gripping force on produce 100, while also shifting it laterally. Accordingly, a lateral shift can be incorporated into the alignment process where necessary.

It is preferred that the rotation step on base support 20 occurs prior to the steps that involve grippers 23. Alternatively, the rotation step on base support 20 may occur after any one or more of the rotation and/or translation steps involving grippers 23.

In some circumstances, it is possible that the anatomical feature 101 may be placed onto base support 20 either facing directly upwards, or directly downwards, such that it is partially (or entirely) obscured from the cameras views. In such a position, rotation by base support 20 may not be able to move the anatomical feature 101 into a position that allows the camera(s) to accurately identify the location of the feature 101.

One preferred method of dealing with such an alignment problem would be for grippers 23, two grab the produce and rotate it, before restarting the normal orientation sequence described above. For example, the grippers may rotate the produce approximately 900 (about a horizontal axis), if the position of the anatomical feature cannot be located.

The vision systems for controlling the cameras and associated software, are already well known in the art. These systems are heavily utilised in existing automated produce sorting applications. The above described system utilises this existing camera hardware and control software. For example, Compaq (and others) have existing sorting systems they can be readily adapted.

### Spiking Unit

As shown in FIG. 5, once the apple 100 has been aligned, a spiking mechanism can be activated, to drive a spike into the produce 100 along the identified natural axis 102 of the produce 100. A puck 31 is loaded adjacent the apple via, for example, puck magazine 32, with the spike 37 of the puck aligned with the natural axis 102 of the apple.

The apple is then spiked along the natural axis 102. Various mechanisms may be used to generate this spiking force. In one configuration, an actuator 30 pushes the apple into the spike. In another embodiment, the puck is pushed into apple still held by grippers 23, against a backplate.

Preferably, the depth is varied depending on specific features, such as the size of the produce. For example, for unpitted stone fruit, the spike the may be adjusted so that the spike only extends a short distance into the fruit and does not encounter the pit.

It is anticipated that the length of the spike 37, may vary with the expected size of produce 100. For example, a number of different sizes may be provided according to the produce desired to be processed.

It is preferred that the item of produce 100 is pushed onto the spike 37, so that the produce 100 is at a set (known) position relative to the base of the puck 31.

Preferably, the spiking depth is controlled (via spiking actuator 30) so that the core (and/or centroid) of the produce is at a fixed and known position relative to the spike 37. This information, combined with data regarding the size and/or shape of the produce, improves accuracy and consistency of the subsequent processing steps (e.g. slicing, coring, chunking and/or carpel tissue removal).

Alternatively, a constant spiking force may be sufficient, to reduce complexity of the system, especially if the produce has already been sorted such that they are all of approximately equal size, for example.

Once spiked, the puck 31 and apple 100 (collectively, puck assembly 35) may be transported, for example via rails 34 and/or conveyor 33 to the next processing station.

### Pucks

Importantly, each puck assembly 35 is an individual, freestanding unit which is preferably not attached to the conveying system. Pucks 31 may be loaded onto the equipment and/or conveyor from magazine 32, for example.

One advantage of this individualised system, is that puck assemblies 35 from the same upstream line can be moved into different streams to undergo different downstream processes. For example, sorting may be according to the size of the produce, or quality of the produce, or produce with detected defects. For example, puck assemblies carrying larger apples may be moved to processing stream which cuts more chunks or slices, thereby achieving more consistent piece size and/or piece weight.

Alternatively, the puck assemblies 35 may be divided into different parallel downstream processes e.g.:
one stream may produce one type of end product like slices, while another stream may produce chunks,
one stream may produce peeled produce, while another stream doesn't,

Alternatively still, the Puck assemblies 35 may be branched into similar or identical processing streams in order to improve productivity.

Additionally or alternatively, the puck assemblies 35 may be sorted according to identified defects. For example, apples with defects may be relegated to a stream designated for canning, juicing or discarding.

Additionally or alternatively, the puck assemblies may be diverted into different streams according to the type of produce. This enables the same upstream equipment to be used for different types of produce simultaneously.

The individual nature of puck assembly 35 also contributes to the flexibility of the system. Production may be scaled by adding or removing puck units, without having to modify the conveyor assembly. Each puck may be replaced or modified without or with minimal change to the rest of the system. Additionally, the individual pucks may be easily and more thoroughly cleaned and maintained since they are not attached to the conveyor system.

Additionally, the pucks function as uniformly sized and stable holders for the individual items of produce. The uniform size allows consistent registration and/or alignment of each item as it passes through each of the subsequent processing steps. The spike 37 provides stable anchoring of each item, preventing it from moving or rotating from its known position relative to the puck base 36.

The specific configuration of the pucks additionally minimises damage to the produce. Firstly, as the spike 37 is preferably relatively narrow, it is configured to only contact and pierce a small portion of the produce. For many types of produce (such as the exemplary apple) the spike pierces the produce through the core which is not used for the premium fresh cut slices and/or chunks for example. Accordingly, there is no or reduced mechanical damage of the most useful and/or premium value portions of the produce. Typically the core is discarded as waste, or used in a low-grade process such as juicing.

Secondly, in the preferred configuration, all registration of the puck assembly (e.g., gripping, rotation required during subsequent cutting and chunking steps) is directly on the base 36 of the pucks, and not on the delicate or external parts of the produce itself. For this reason, the base 36 of the puck is preferably larger in diameter than the produce. This also reduces the risk of the sides of the items of produce contacting or hitting parts of the equipment during transport.

Thirdly, in the preferred embodiment, each item of produce is transported on a single puck throughout the entire process so there is no need to transfer each item to different holders on separate stations. This minimises direct handling and manipulation of the produce, hence further reducing damage.

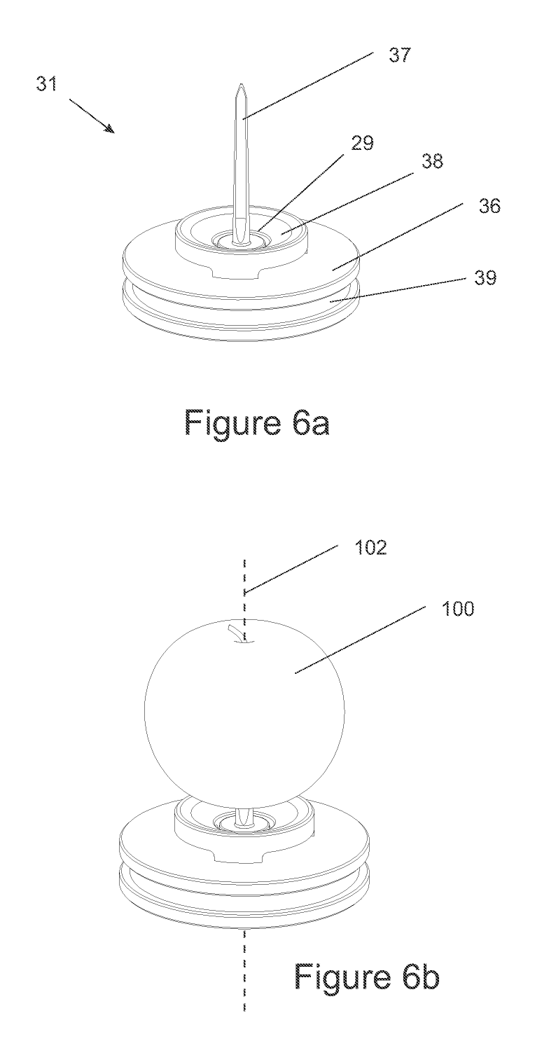

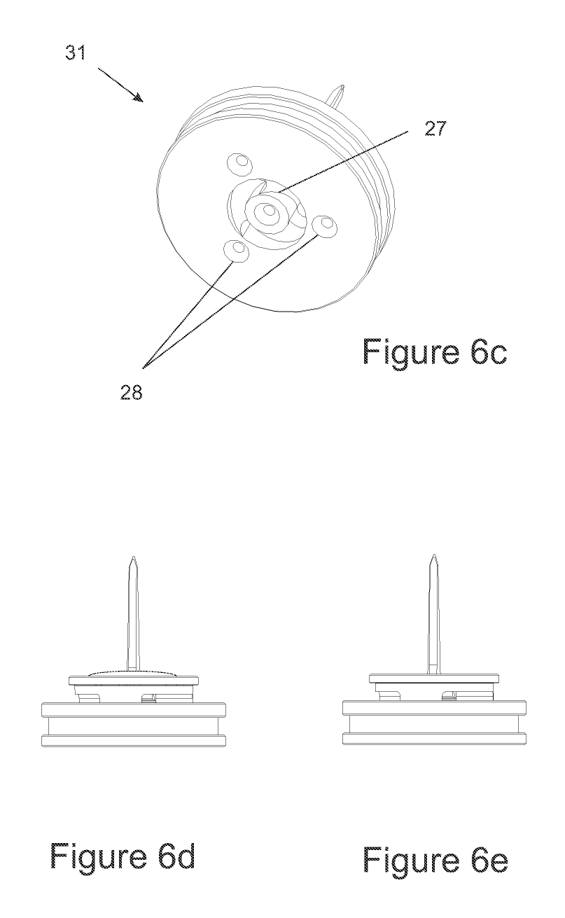

Detailed views of the puck 31 and puck assembly 35 are shown in FIGS. 6a and 6b respectively.

Preferably, spike 37 is tapered slightly to aid in the removal of the remaining portion of the produce from the spike in a downstream process. Preferably the spike 37 further narrows towards its tip to reduce the amount of force needed for spiking into the produce.

Optionally, the spike 37 maybe fluted, preferably along substantially its entire length. This prevents the produce from rotating on the spike, and may be particularly helpful when the further processing requires the produce to be rotated.

It is anticipated that the size and shape of the spike may be varied depending on the application. For un-pitted stone fruit, for example, the spike may be shorter so that it does not encounter the pit of the fruit.

In one configuration, the top face of base 36 of the puck is preferably sized and configured such that it is substantially complementary to the shape of the base of the item of produce. For example with reference to FIGS. 6a and 6b, the central portion 38 of the base 36 may be concave so that it is approximately complementary to the convex base of apple 100. The base 36 therefore cradles the apple 100 should the apple contact the base. This prevents localised pressure on portions of the base, if the produce 100 comes in contact with the base during one or more processing steps.

Alternatively, the top face of base 36 of the puck 31 may be convex as illustrated in FIG. 6d. Alternatively still the top face of base 36 of the puck 31 may be flat as illustrated in FIG. 6e.

Alternatively still, the top face of base 36 of the Puck may be shaped so that it is not complementary to the shape of the base of the item of produce being processed.

Additionally or alternatively, the top face of base 36 of the puck may comprise one or more grooves 29 which provide cutting relief to accommodate the core tube 52 during the subsequent coring process (discussed in more detail below).

The bottom face of base 36 of the puck is preferably substantially planar for increased stability as the puck is conveyed through the system.

Additional registration features such as groove 39, may be provided in order to aid handling of the puck 31 through the processing system. For example, groove 39 may aid gripping, manipulating, and/or prevent tipping.

As shown in figure c, further registration features, such as detents 28, may be provided to facilitate the receiving of a complimentary shaped member (for example a drive dog), in order to provide a means for rotating puck 31, for example.

Alternatively to, or in conjunction with those described above, spiral ramped registration features 27 may be provided, to facilitate smooth engagement with a rotating drive feature.

Additionally, further markings and/or features may be provided as reference points to establish an orientation of the puck. This could, for example, assist with identifying and recording the position of a localised defect on the produce, for example.

### The Chunking Station

The puck assemblies may be conveyed to an optional chunking station 6 if chunking is required. In FIG. 1, the chunking station 6, is shown in dotted lines to denote that it is an optional operation. “Chunks” refers to the end result of cutting the produce into approximate cubes, although it will be appreciated that the irregular shape of natural produce coupled with likely cuts being oriented radially, do not produce actual geometric cubes. For example, the produce may be cut along a first set of substantially parallel horizontal planes, then along a second set of radial planes which are at approximately right angles to the first set, to produce “chunks”.

In one configuration, the produce 100 is first passed through a chunking station 6 which cuts the produce along a first set of substantially parallel planes. The produce 100 is subsequently passed through a slicer 8, which cuts the fruit along radially extending planes, producing chunks of produce. Accordingly, the term “chunking” when used in reference to the chunking station 6 refers to cutting the fruit along the first set of planes.

If chunking is not required, this step may be bypassed, for example by diverting the conveyed stream or by moving (or removing) the chunking blades.

One preferred configuration of the chunking station 6 is shown in FIG. 7. Two stacks/columns of blades 40a, 40b are positioned adjacent each other, each stack aligned substantially vertically (parallel to the direction of the natural axis of the produce in operation as the puck assemblies move between the blades).

The stacks of blades 40a, 40b rotate in a manner which is synchronised with the movement of the produce between the blades. That is, the blades move with the produce 100 while cutting it, thus minimising the movement of the blades with respect to the produce. This produces clean cuts and minimises bruising of the produce, (e.g. Compared to rapidly spinning blades).

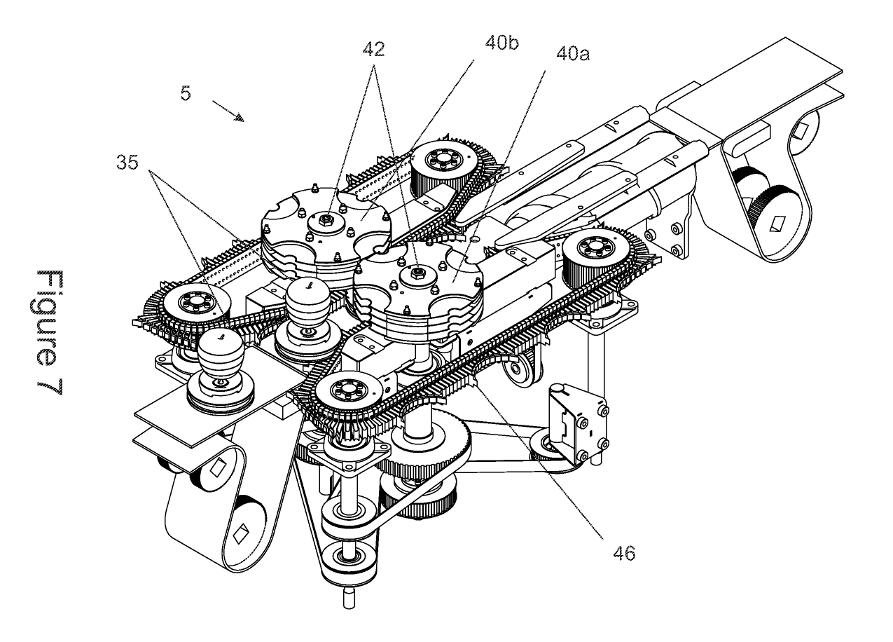

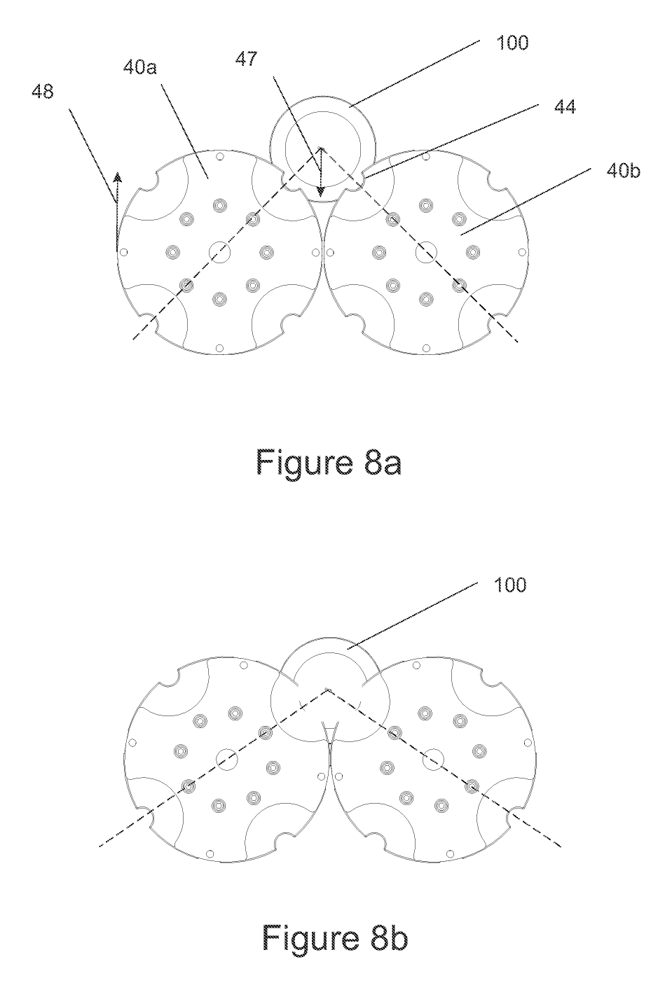

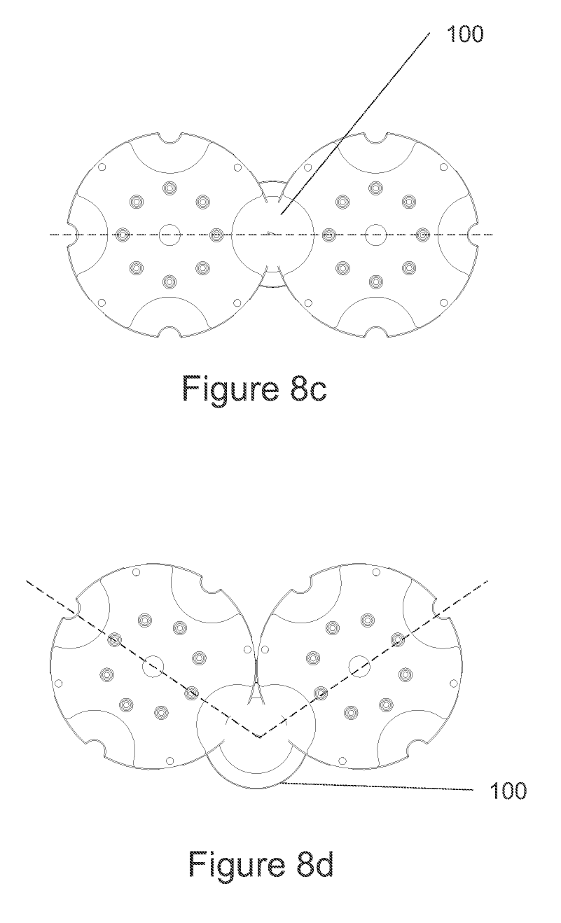

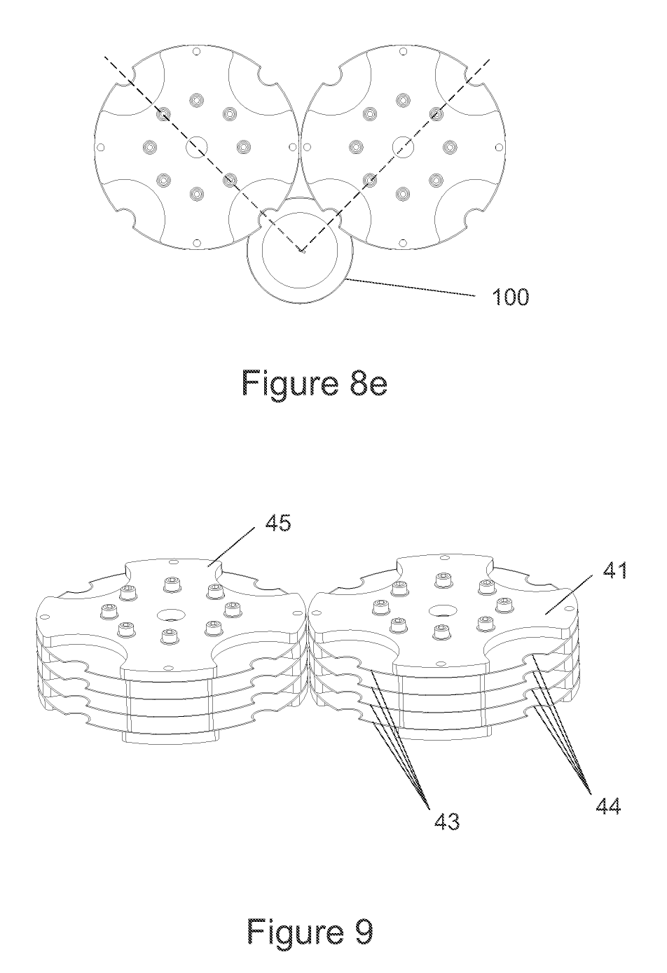

Specifically, the movement of the blades is synchronised with movement of the produce such that the linear velocity of the produce (indicated by arrow 47) is equal to the tangential velocity of the blades at a blade tip (indicated by arrow 48). This is shown schematically in FIGS. 8a-8e.

FIG. 8a shows an item of produce 100 entering rotating blade stacks 40a,40b. FIG. 8b shows produce 100, as it has progressed further through the chunking blades. FIG. 8c shows produce 100 halfway through the chunking blades. FIG. 8d shows the produce 100 almost entirely through the chunking blades, while FIG. 8e shows produce 100 emerging from the chunking blades.

As a result of this synchronisation, relative movement between the blades and the produce is minimised, and the produce is effectively cut along substantially a single plane, in a guillotine-like action.

This is an improvement over conventional chunking mechanisms, in which there is substantial movement of the blades relative to the produce (e.g., rotating produce is brought into contact with the blades or produce is brought into contact with rotating blades). Such conventional “scoring” of the produce is undesirable as the relative movement excessively shears, scrapes and/or tears the produce, and generates unnecessary bruising and oxidation on the cut surfaces.

In a preferred embodiment, each blade has a plurality of cutting regions. For example, the blades shown in FIGS. 7-9 each have four cutting regions spaced around the perimeter of the disc blades, such that four items of produce may be sliced sequentially on each rotation of the blade stack.

The central portion of each cutting region is therefore substantially the centre of the arc length of each cutting region. Alternatively, each blade may only have a single cutting region. The central portion of each cutting region is the centre of cut-out 44 if cut-outs are provided (described in more detail later).

Synchronisation of the blades with movement of the produce may be provided via various means. In the preferred embodiment, the produce is conveyed on pucks 31, and the base of the puck keys with a registration feature of the chunking station as each puck assembly moves through the blades.

In a preferred configuration illustrated in FIG. 7, this registration feature comprises conveying fingers 46 driven by or synchronised with, the drive belt driving rotation of the blades. The fingers 46 engage, support and drive the pucks between the blades. The length of fingers is varied according to a predetermined pattern, as shown in FIG. 7. As a result, each puck, when engaged, is spaced apart from adjacent pucks. In this way, the speed and/or configuration of the fingers synchronises the movement of each puck with movement of the blades.

A close-up view of the blade stacks 40a, 40b in isolation is shown in FIG. 9. The stacks are preferably positioned adjacent and opposite each other, but not contacting or overlapping each other.

According to one configuration, each stack comprises four disc-shaped blades 43, spaced apart from each other via the housing 41 or supporting means 42. The blades 43 are preferably substantially circular in plan view. Any alternative number of blades and/or alternative spacing between the blades may be provided, depending on the requirement of the chunking process. For example, only one blade may be provided in each stack, if produce halves are desired.

In a preferred configuration, each blade 43 comprises cut-outs 44. These cut-outs are sized and positioned to accommodate for the core of the produce and/or spike of the puck. The cut-out 44 on each blade is preferably at least approximately semi-circular, and positioned so that cut-outs on adjacent blades coincide to form proximally circular apertures for receiving the core of the fruit.

That is, the movement of the blades and the puck assembly is synchronised so that the cut-outs are positioned to surround the core region of the produce while the cutting regions of the blade adjacent the cut-out, slice through the outer portion of the produce

As a result, preferably only the outer portions the produce is chunked; the core or inner region remains uncut, so that the produce remains securely on the core/puck for further processing. That is, the sliced sections or discs of produce remains core-supported, as illustrated in FIG. 7.

In the preferred embodiment, the blades rotate a quarter turn for each puck assembly which passes through. Each cut-out 44 is therefore positioned to accommodate the core/inner region of the item on one puck assembly. It will be appreciated that the number and size of the cut-out may be varied depending on the size of the produce, and/or the size of the core of the produce.

Preferably, the blades are sized so that there are multiple cut-outs 44 on each blade 43. Since only a portion of the blade is used for each fruit, this increases efficiency of the system, and reduces maintenance requirements. Specifically, each blade will require less frequent cleaning and sharpening since multiple cutting surfaces are provided on each blade.

Optionally, the blades may comprise a second set of cutting surfaces (and/or cut-outs 44), which are covered by shield portions 45 of the housing in operation. Accordingly, the blades may be quickly rotated 45 degrees within the housing to expose a new set of cutting surfaces (and/or cut-outs) when necessary, thus reducing the need to replace the entire stack of blades.

As may be appreciated, the cassette form of the blade stacks 40a, 40b improves flexibility of the system. The blades may be easily removed for cleaning and maintenance, or replacing with other configurations of blades in order to adapt the system for other types or sizes of produce. Additionally, the blade supports 42 are preferably adjustable, to modify the overall height of each blade stack.

### Corer and Slicer

The puck assemblies may subsequently or alternatively (if chunking is not required) be conveyed to the corer 7 and/or slicer 8 assembly. FIG. 10 shows a preferred configuration of a carousel 50 which performs both the coring and slicing processes. The eight station carousel 50, is illustrated as an example. Further, for illustration purposes, only three coring/slicing stations 51 are shown in detail.

Preferably, the puck assemblies 35 (shown without produce) are loaded automatically onto each station, so that the puck base 36 registers substantially securely in holding means at each station.

Above each station is a hollow core tube 52, which is movable substantially vertically (binary suitable means such as pneumatically, by servo motor or hydraulically).

Additionally, above each station and surrounding the core tube 52 is preferably a segmented ram 54, which is also movable substantially vertically, and independently of the core tube 52. Below each station is a slicing blade assembly 53, comprising blades arranged radially for slicing the produce into quarters or wedges of other sizes as required.

In one example, the apple 100 on puck assembly 35 is cored first, as core tube 52 is actuated to descend and cut through the apple. Preferably, the core tube contacts or is received in a cutting relief feature of the puck base (as described above).

When the core tube 52 is subsequently raised, the core of the apple remains on the spike 37 of the puck, while the edible outer portion of the apple is held on the core tube. If previously chunked (by the chunking blades), the core tube 52 will now be supporting annular sections of the produce (sections that were previously core-supported).

The puck (with spike-attached core) may be ejected pneumatically, etc, the core removed from each puck and the puck cleaned to be reused. In another embodiment, the puck (with spike-attached core) is conveyed away on another line for juicing and/or cleaning.

The core tube (with outer portion of apple attached) is then lowered so that the apple is substantially adjacent the slicing blade assembly 53. The ram 54 may be lowered simultaneously or subsequently, onto the top of the apple, to push the apple onto the slicing blade assembly 53. The apple is sliced as it passes through the blades (or chunked if it was passed through chunking station 6 beforehand).

Preferably the shape of the slicing blade assembly 53, as well as the bottom surface of ram 54 (which preferably substantially cups the top of the apple), are preferably configured to reduce splaying of the apple as it is sliced. This results in cleaner cuts, and therefore reduced bruising and browning of each slice.

Since the apple is held securely via the puck during the coring cut, there is no external pressure on most other parts of the apple, thus reducing damage to the premium edible outer portion. That is, all or a significant portion of the pressure is applied to the core instead of the outer portion of the apple.

With particular reference to FIG. 11, one preferred sequence of processes (not including chunking or peeling) is set out in detail.

According to one alternative preferred configuration including chunking, the diameter of the core tube is preferably sized corresponding to or slightly larger than the diameter of the cut-outs 44 of the chunking blades, so that the coring cut is made either at the edge of the chunking cuts, or external to the edge of the chunking cuts, therefore producing clean cuts and reducing wastage.

The end product (wedges, cubes, or slices) may then be transported away for further processing and packaging, e.g., soaking of the fresh-cut product in antioxidant, such as disclosed applicant's U.S. Pat. No. 7,217,358.

### Carpel Tissue Removal

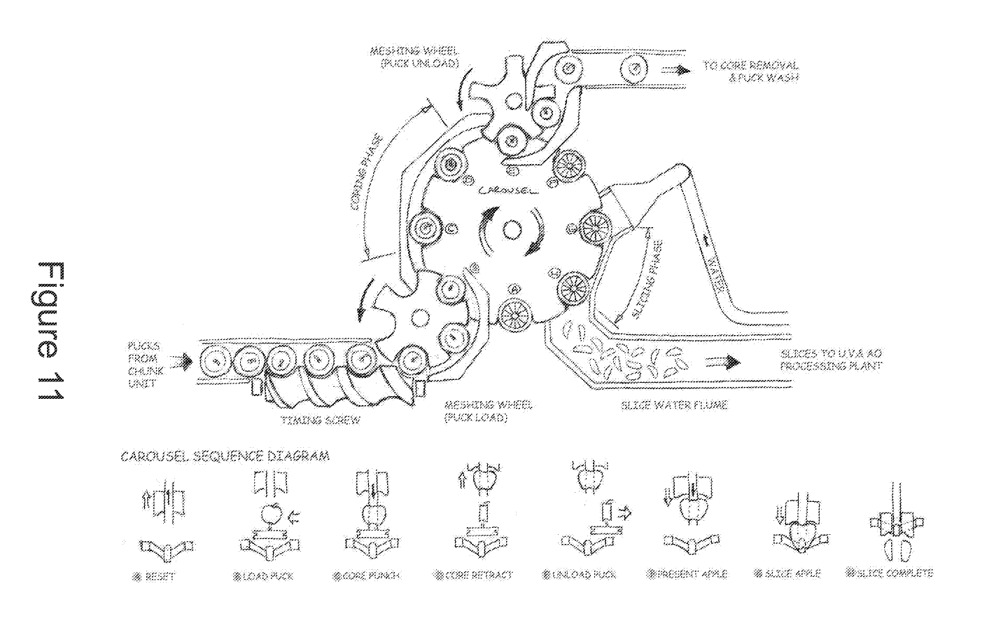

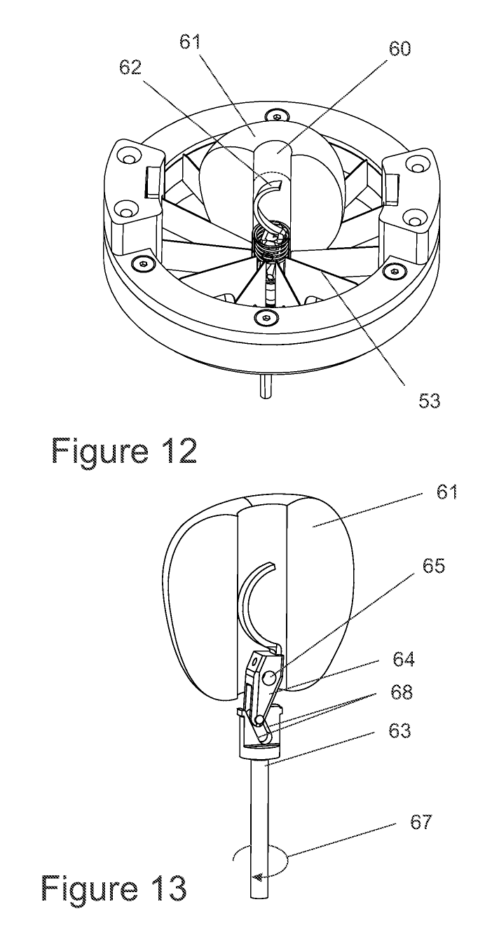

With particular reference to FIGS. 12-14, an optional coring apparatus and processing step may be employed in alternative embodiments. The aim of this additional step is to remove the core and/or seed cell (carpel tissue) of the produce which may be larger in diameter and located at approximately the centroid of the fruit/produce.

For embodiments employing this additional step, the process proceeds substantially as above with the core tube 52 being actuated to descend and cut through the apple 61. Preferably, the core tube 52 contacts, or is received in a cutting relief feature, of the puck base, and pushes the apple to the bottom of the spike during coring. It is preferred that the action of pushing the apple to the bottom of the spike utilises displacement detection (on ram 54, for example) to measure the size of the produce at this stage.

When the core tube 52 is subsequently raised, the core of the apple 61 remains on the spike 37 of the puck, while the premium outer portion of the apple is held on the core tube. The spike and core (supported on it) can then be moved away, as before.

The core tube (with produce attached) is then lowered so that the apple 61 is substantially adjacent the slicing blade assembly 53. The ram 54 (not shown in FIG. 12) may be lowered simultaneously or subsequently, onto the top of the apple, to push the apple 61 onto the slicing blade assembly 53, a small amount until the blades just penetrate the produce, but does not push the produce through to complete the slicing of the produce (as shown in FIG. 12).

Either before, simultaneously or subsequently to movement of apple onto the blade assembly 53, the apple is pushed partially off the core tube 52 (by independently actuatable segmented ram 54), so that only a lower portion of core tube 52 remains engaged within the apple (that is, in upper cylindrical cutout 60).

As a result, the apple is supported in an upper region by the partially withdrawn core tube 52, and in the lower region by the partially penetrating blade assembly 53.

The apparatus preferably uses the size information measured earlier to calculate how far to push the apple into the blades and/or how far to retract the core tube. Alternatively, the ram 54 can push the produce 100 into the blades a predetermined amount.

In this embodiment, the central portion of the blade assembly 53, is hollow and includes a retractable sweeping carpel blade 62. FIG. 12 shows the carpel blade 62 in an extended position, with the carpel blade assembly extending into the cylindrical cutout left by the removal of the core by the core tube 52. Once again, the apple size information may be utilised to extend the carpel blade 62 into the apple, so that the centre of the sweeping carpel blade is aligned with the expected centroid of the apple.

It will be appreciated that less spherical produce (such as a pear for example), will locate the sweeping carpel blade 62 accordingly (i.e. In the lower bulb region of the fruit). Anatomical trends for each type of produce can be used to determine an expected location of the material within the produce desired to be removed in this step. The positioning of the carpel blade 62 can then be tailored accordingly.

In its retracted position, the carpel blade 62 is preferably located below the blade assembly and does not interfere with the core tube 52 passing through the fruit and/or the apple being pressed onto the blades 53.

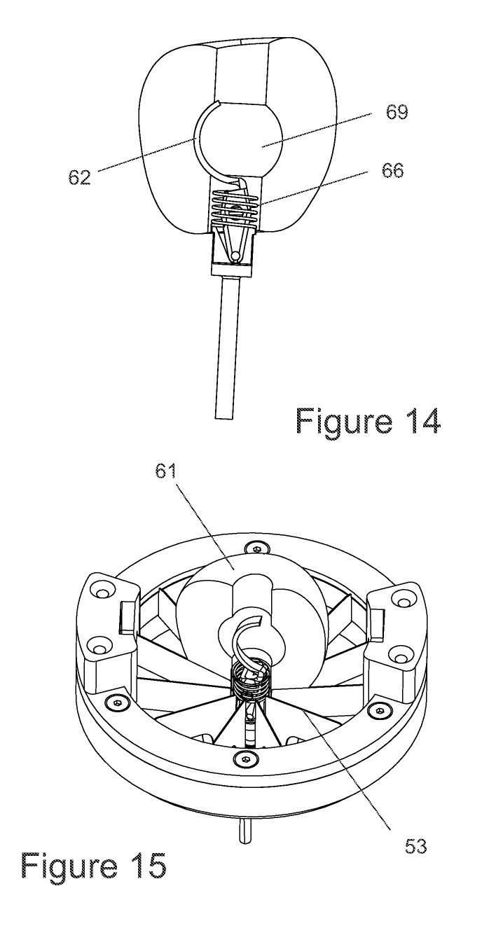

With particular reference to FIGS. 13 and 14, the operation of the sweeping carpel blade 62 will be described in more detail. FIG. 13 shows the carpel blade assembly extended and in position with the carpel blade 62 aligned with the centroid of the apple 61.

Carpel blade 62 is mounted on blade holder 64 which is pivotally coupled about pivot pin 65. The assembly is housed in a tube (not shown for clarity), and the carpel blade 62 extends out the end of the tube when fully extended. Plunger 63 is coupled to the lower end of blade holder 64 via camming surfaces 68. As illustrated in FIG. 13, carpel blade 62 is in a radially contracted condition, and fits within the cylindrical void left by the core tube 52.

As plunger 63 is moved upwards, the camming surfaces 68 of blade holder 64 causes the blade holder to pivot about pin 65, thus in turn, the carpal blade 62 will be radially expanded. At the same time as plunger 63 is raised, plunger 63 is also rotated in the direction of arrow 67. The combined rotation and radial expansion of carpel blade 62 causes the blade to sweep around the apple core along a path of increasing radius (or a spiral).

It is preferred that the increasing radius path is relatively gradual so that the carpel blade 62 removes a small amount of core material as it makes several revolutions. Further, once the carpel blade 62 has reached the desired radially extended position, the blade sweeps at least another full revolution. As a result, the void formed by the carpel blade 62 is a symmetric swept volume.

Alternatively, the carpel blade 62 may be driven by servo motors, or other suitable means to precisely control the blade. It may be preferable to directly couple the blade 62 to ensure that the blade takes up its radially retracted position in order to make sure it can be removed from the produce reliably.

The end result (as shown in FIG. 14), is an apple with a hollowed out seed cell/core. Carpal blade 62 as shown in its maximum radially expanded position. Plunger 63 can then be moved downwardly (assisted by spring 66), so that the carpel blade 62 returns to its radially contracted state as shown in FIG. 15. Finally, the carpel blade assembly can be moved downwards so that the carpel blade is entirely removed from the apple. Some of the sliver of carpal tissue, may then fall out of the bottom of the apple. It will be appreciated that the apple is held to resist rotation (while the carpel blade operates) because it is partially pushed onto blade set 53.

The apple can then be pushed all the way through the blades 53 to complete the slicing process. Any remaining core tissue slivers will fall into the flume and can be removed via a graded sieve for example.

It will be appreciated that the degree of radial extension of carpel blade 62 may be varied according to a number of parameters such as, the type of produce, the size of the particular piece of produce, or any other relevant criteria.

Similarly, the shape of carpel blade 62 may be varied to suit particular types of fruit or sizes of produce to be processed. Preferably be carpel blade 62 is curved so that when it is swept around a revolution, it removes a volume of material shaped to correspond with the undesirable seed cell/core of the relevant produce.

Importantly, the handling of the produce in this way allows improved access to any remnants of the seed cell and/or core of the produce. Typically, the seed cell is located around the centroid of the produce. Accordingly, the premium flesh of the produce can be maximized by utilizing a sequence of cutting/coring operations occurring in different planes, so that more material can be removed from a location centrally within the produce.

Traditional coring techniques use only a core tube and therefore, in order to ensure most, if not all, of the seed cell and carpel tissue is removed, a larger core tube diameter is required.

It will also be appreciated that the “centroid” of the produce 100 may, or may not, be the actual geometric centroid of the produce 100. This term is used for convenience to denote a region within the produce that is desired to be removed.

In particular, the above method may improve the yield of premium produce flesh extracted from each item, by allowing a relatively smaller core tube diameter. Due to the use of the secondary sweeping carpel blade 62, the diameter of the core tube need only be large enough to reliably remove elements of the core adjacent the stem and calyx of the produce. Any core/seed material around the centroid of the produce left behind because it is outside the diameter of the core tube, can be removed by the sweeping carpel blade 62.

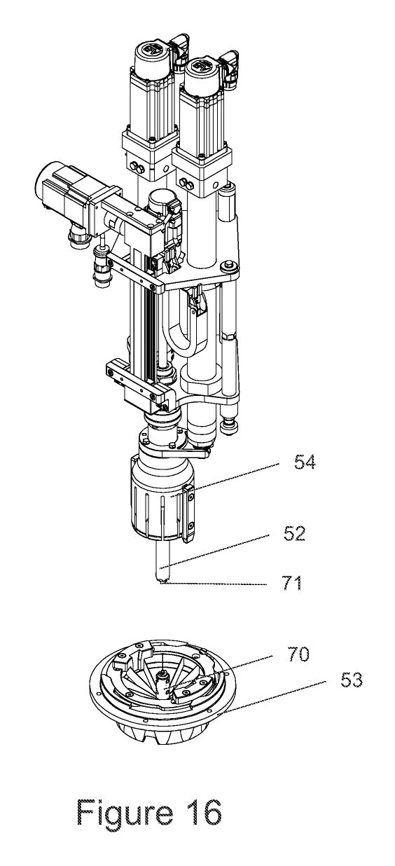

With particular reference to FIGS. 16-18, an alternative optional carpel tissue removal apparatus will be described.

Like the process described above, the aim of this additional step is to remove the core and/or seed cell (carpel tissue) of the produce which may be larger in diameter and located at about the centroid of the fruit/produce.

In this configuration, the cutter assembly 70 is also located in the central portion of the blade assembly 53, and is configured to spin around the central blade hub.

In one configuration, the cutter assembly 70 may be retractable within a hub portion of cutter assembly 53. In alternative configurations, the cutter assembly may be mounted on the blade assembly 53 such that it can spin, but not retract.

In order to drive the cutter assembly 70, and engaging drive tip 71 is housed within core tube 52. Drive tip 71 is independently retractable within core tube 52 so that it can extend beyond the end of the core tube 52, and down to the cutter assembly 70 when required.

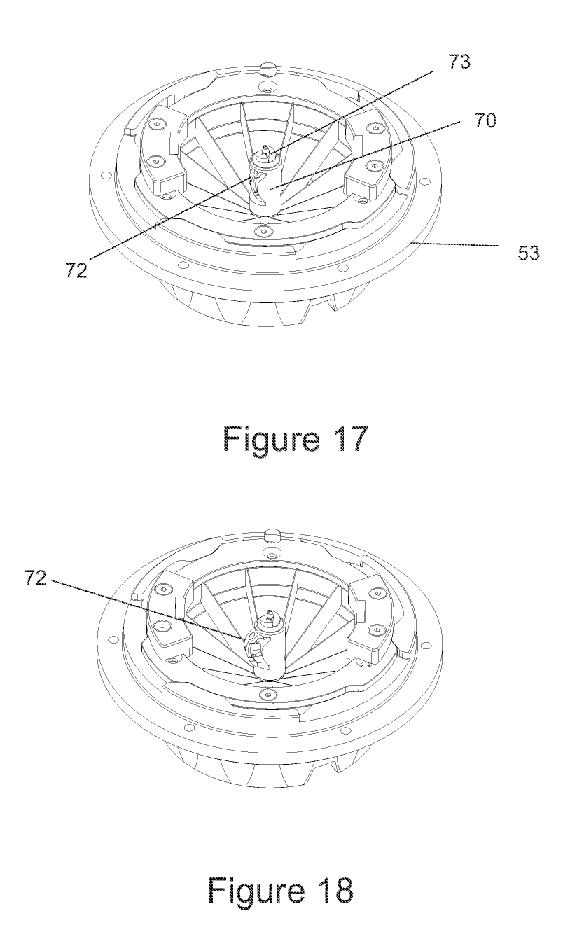

With reference to FIG. 17, cutter assembly 70 is shown with carpel tissue blade 72 shown in a retracted position. Preferably drive tip 71 of the core tube 52, is configured to engage with ramped drive surfaces 73, in order that the cutter 70 can spin.

As shown in FIG. 18, carpel blade 72 can be moved radially outwardly via an appropriate actuator. For example, a pneumatic actuator fed from within cut 70 may be utilised. Accordingly, a positive pressure will force the blade radially outwards, while an applied vacuum pressure may be utilised to retract the blade once the cutting operation is finished.

Preferably be carpel blade 72 is curved so that when it is swept around a revolution, it removes a volume of material shaped to correspond with the undesirable seed cell/core of the relevant produce, as described above in relation to the alternative embodiment.

In order to align the carpel blade 62 with the centroid of the apple 61, the segmented ram pushes the produce partially into blade set 53, substantially as described above in relation to the alternative carpel tissue removal.

Similarly, the core tube 52 is partially removed from the produce to keep the core tube out of the way of the spinning cutter 70. However, as described above the apple is supported in an upper region by the partially withdrawn core tube 52, and in the lower region by the partially penetrating blade assembly 53. The apparatus uses the size information measured earlier to calculate how far to push the apple into the blades and/or how far to retract the core tube.

The blade 72 can be spun at high speed, to effectively mulch and/or puree the carpel tissue.

This configuration of the cutter 70 provides the advantage of the drive 71 and associated actuators being located above the cutter blades 53 (i.e. on the carousel). This substantially prevents material cut from the produce falling into the drive mechanism, and also allows the blade assemblies 53 to be simplified. The simplification of the blade assemblies 53, allow them to be more easily removed. This is a significant advantage because the blade assemblies 53 are required to be removed for sharpening and/or cleaning regularly.

Removal of the blade set 53 may be facilitated by disconnecting a single pneumatic line, and releasing a simple retaining mechanism.

### Peeling

For configurations where peeling of the produce 100 is desired, an additional peeling station can be provided and operated. It will be appreciated that the peeling station 5 may be removed, and/or produce diverted, and/or the peeling station de-activated, if peeling is not required.

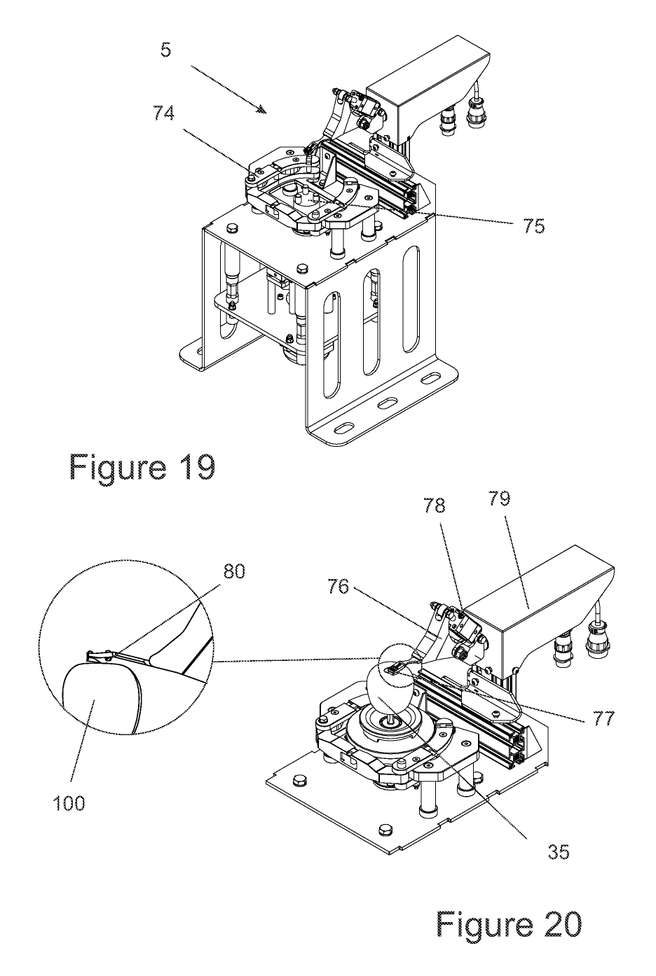

With reference to FIGS. 19-22, a preferred optional peeling station 5 will now be described.

Peeling station 5 includes a holding frame 74 for receiving and retaining puck assemblies 35 (including produce 100), in a rotatable manner. Holding frame 74 may preferably include rollers in order to reduce friction where the puck 31 contacts the frame 74 when rotated. In particular, holding frame 74 preferably engages puck 31 via groove 39 to provide additional stable support when rotated.

Peeling station 5 also preferably includes a means for receiving and ejecting puck assemblies 35. For example, the holding frame 74 may include at least one gate in order to allow entry and/or exit of the puck assembly 35. When the gate is closed, the holding frame 74 extends around a substantial portion of the periphery of the puck assembly 35.

Alternatively, the puck assemblies 35 may be loaded and/or unloaded from above (i.e. axially in line with drive dog 75).

In order to facilitate rotation, a drive dog 75 is provided and includes engaging features configured to engage and register with complimentary features 28 on the base of the puck 31 (as described above and illustrated in FIG. 6c).

As shown in FIG. 20, puck assembly 35 is loaded into the peeling station 5. Underneath the puck assembly 35, the drive dog 75 is engaged with features 28 in order to rotate the puck assembly 35. Peeling head 76 is shown in position such that peeling blade 77 is located towards the top of produce 100, and offset laterally to one side.

The position and/or pressure applied to the peeling blade 77 against produce 100, can be controlled via peeling actuator 78. It will be appreciated that extension of actuator 78 will press the peeling blade 77 on to produce 100 (in a generally downwards direction as shown in FIG. 20). Actuator 78, can also move the peeling blade 77 right out of the way to facilitate loading and/or unloading of the puck assemblies 35.

The peeling head actuator 78 may be of any suitable type. Preferably the actuator allows accurate control of the pressure and/or displacement of the peeling blade 77. For example, the actuator 78 maybe pneumatic, or a servo motor, or electromechanical or hydraulic.

In the position illustrated in FIG. 20, it will be appreciated that clockwise rotation of the puck assembly 35 will cause the peeling blade 77 to cut a ring of ‘peel’ circumscribing the stem of the apple.

With reference to FIG. 20, a close-up of the peeling blade 77 as shown from a side on perspective. In this view, the tip of the peeling blade 77 is clearly shown. Optionally, an adjustable stop 80 may be provided. This stop feature 80, provides a bearing surface which when pushed onto the surface of the produce 100 controls the depth of the peeling blade 77 penetrating into produce 100, preventing the blade from peeling too deeply.

In the most preferred configurations, the peeling blade 77 is pressed against the produce 100 with a substantially constant pressure. The stop 80 is particularly useful for preventing the blade 77 from biting into the produce too far, when controlled in this pressure based mode of operation.

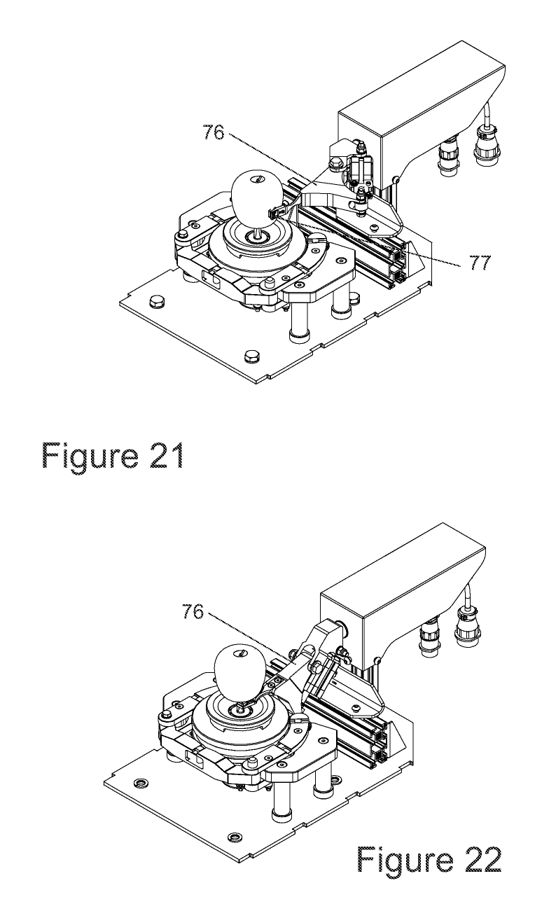

In order to peel the entire surface of the produce, the peeling head 76 is rotated about the peeling head housing 79. FIG. 21 shows the peeling head 76 rotated about 90°, so that the peeling blade 77 is located approximately halfway down the outer surface of produce 100. It will be appreciated that the speed of rotation of the puck assembly 35 and rotation of the peeling head 76 can be synchronised in order to ensure that peeling blade 76 covers the entire surface of produce 100.

It is preferred that the peeling station in one configuration, controls the rotational speed of puck assembly 35, to keep a constant tangential speed of peeling blade 77 with respect to the rotating produce surface. In order to achieve this, the peeling station can use information about the geometry of the produce 100 determined earlier.

Alternatively, the position of the actuator 78 allows calculation of the geometry of the produce 100, and therefore the tangential speed of produce moving past blade 77. Accordingly, a servo motor is preferred as the actuator for rotating drive dog 75.

With reference to FIG. 22, the peeling heat 76 is rotated a further 90°, and as shown and positioned port bottom of produce 100. In this position, the blade 77 is offset laterally from the core axis and is preferably prevented from impacting the spike 37.

It will be appreciated, that after approximately 180° of movement by the peeling head 76, almost the entire surface will have been peeled.

### Core Removal

As described above, the outer flesh of produce 100 is removed from the core which remains on the spike 37. However, the core material may not necessarily be discarded as it still potentially has some value.

For example, the core can be used for juicing and/or the seeds may be extracted. In order to achieve this, the core needs to be removed from the spike. In particular relation to harvesting seeds, the inner core needs to be broken open to access the seeds.

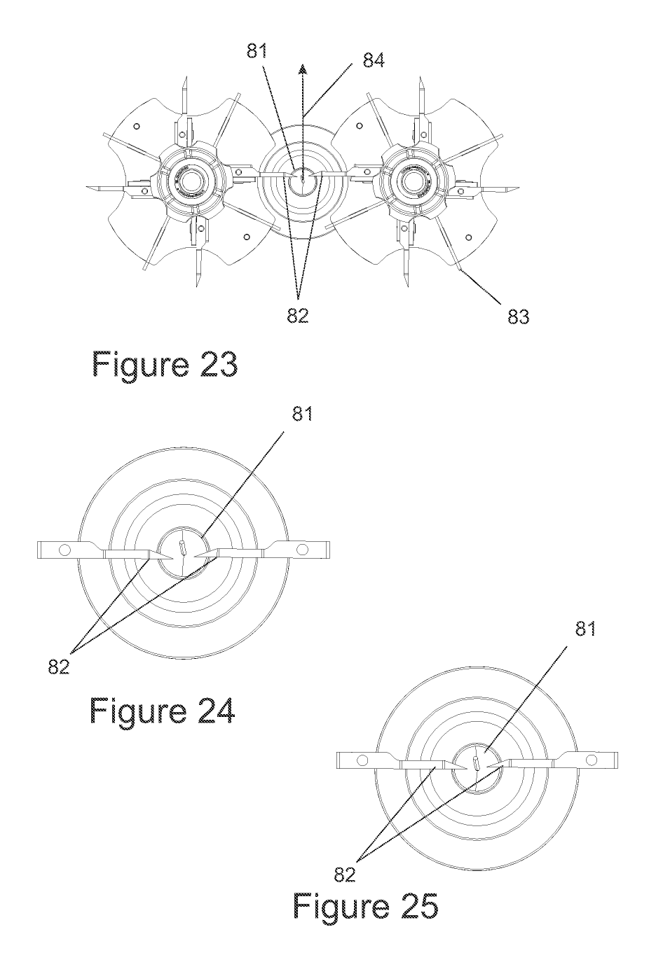

With particular reference to FIGS. 23 to 27, a preferred configuration of a core removal and/or seed harvesting station 13 will be described.

It has been found that it is possible to make significant cuts on the spike mounted core to weaken the grip of the core on the spike, without cutting the core off the spike at the point of cutting. In particular, the core can be broken open, but preferably not completely removed from the spike during the first part of processing, in order to allow the spike mounted core to move past the conveyor elements, thereby reducing the amount of debris being introduced into the moving parts.

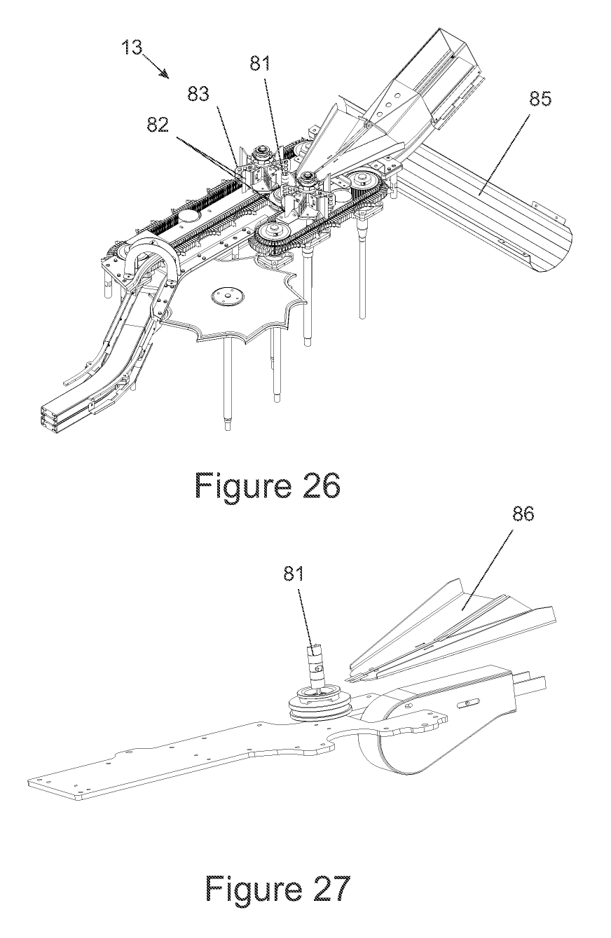

As shown in FIG. 26, a core slicing and removing station 13 is preferably provided. In this configuration, the puck assemblies 35 (including the core 81), are conveyed through a pair of rotating blades 82. In one preferred configuration, the conveyor is similar to that described in relation to the chunking station above.

Rotating blades 82 preferably are arranged in a radial fashion and each blade assembly includes a number of radially spaced blades 82. The rotation of blades 82 is synchronised so that the blades move at the same speed and aligned with each other as described in more detail later.

In some configurations, shields 83 are provided at radial spacings between each set of blades 82. The purpose of the shield is to push any core remnants that may break off the spike through the machinery.

With particular reference to FIG. 23, a core 81 passes between the rotating blades, in a synchronised manner. It is preferred that the blades 82 do not extend all the way to where the spike is expected to be located, to avoid clashes. That is the blades do not reach each other, and a gap (sufficient for the spike to pass through) exists.

As shown in FIG. 23, preferably the blades 82 are synchronised so that they align slightly forwards of the centre of the core/spike, as they pass between the blades in direction of arrow 84. It is feature allows the blades to make a deeper at insertion into the core 81. Further, by timing the cuts to be offset from this spike 37, the trailing part of the core will have sufficient wraparound the spike allowing it to continue to travel with the puck.

It is preferred that the leading part of the core is still attached, as the cut is not all the way through the core flesh.

In alternative configurations, the blades 82 may be synchronised so that they align slightly behind the centre of the core/spike, as shown in FIG. 24.

In further alternative configurations, the blades 82 may be synchronised so that they align with the centre of the core/spike, as shown in FIG. 25.

It has been found that it is preferable for blades 82 to be thick enough in order to split the core apart as it is driven in. However, the blades are preferably not so thick that they put undue load on the spike as the core 81 is removed.

According to one configuration, the blade 82 width is approximately 5 mm, which has been found particularly effective for apples.

In some embodiments, it may be preferable for the blades 82 to also be reasonably blunt, rather than very sharp. Further, the blades 82 may be angled on one (facing forwards or backwards), or both sides. It is anticipated that different blade shapes will work better with various produce types.

The spike mounted core 81 is typically under some internal pressure from the spike trying to splay the core outwards. Accordingly, the blades 82 act as a stress relieving mechanism that initiates the core to split apart, as the blade sweep into and out of the core in order to make a cut.

Due to the rotating motion of blades 82, the speed of the blade tip (in the direction parallel to the puck travel indicated by arrow 84), is not constant along different points of the blade 82. The difference in speed may assist in breaking the leading and trailing halves of the core apart.

The core will preferably remain on the puck post incision, but will have a weaker hold on the spike due to the incision. The wedge blades 82 loosen the core from the spike and the core will be directed into the flume by covers. The core will be shielded from any interaction with the fingers and belt mechanism when it has been wedged off.

With particular reference to FIGS. 26 and 27, the final removal step of the core 81 from the puck 31 will be described. After passing through rotating blades 82, the puck assembly 35 (with split, but preferably attached core 81), reaches ramp 86. The tip 87 of ramp 86 is positioned to be slightly above the puck base, and to preferably slide under core 81.

Ramp 86 has a central split running along its length to allow the spike 31 to pass through. It will be appreciated that the inclined ramp 86 will effectively lift Park 81 upwards of the spike. Once it has been freed, the core can be injected into chute 85, for further processing as desired.

Preferably, jets of water may be directed at the puck in order to remove any remaining core and produce flesh left on the puck.

The empty pucks 31, can be conveyed away for final washing and/or sterilising and eventually can be reintroduced into the processing system and reused.

The foregoing description of the invention includes preferred forms thereof.

Modifications may be made thereto without departing from the scope of the invention as defined by the accompanying claims.

1. Apparatus for processing produce comprising:
a plurality of freestanding pucks for carrying items of produce, each puck comprising
a base and a spike extending from the base,
an actuator configured to pierce an item of produce with said spike and hold the item in a substantially fixed position relative to the base.

2. The apparatus of claim 1, wherein the piercing is along a natural axis of the item of produce.

3. The apparatus of claim 1, wherein the spike is fluted along at least a majority of the length of the spike.

4. The apparatus of claim 3, wherein the spike is tapered towards a tip of the spike, and said taper extends substantially the entire length of the spike.

5. The apparatus of claim 1, wherein the base of the puck is substantially circular in plan view.

6. The apparatus of claim 1, wherein the base of the puck comprises a top face from which the spike extends, a bottom face, and one or more side faces extending between the top face and the bottom face.

7. The apparatus of claim 6, wherein the spike extends substantially perpendicular to the top face from a central portion of the top face.

8. The apparatus of claim 6, wherein the central portion of the top face is concave.

9. The apparatus of claim 6, wherein the top face comprises a cutting relief sized to accommodate a core tube.

10. (canceled)

11. (canceled)

12. (canceled)

13. (canceled)

14. The apparatus of claim 1, further comprising at least one blade for performing at least one reduction operation on said produce.

15. The apparatus of claim 1, wherein each item of produce remains on a single puck throughout the processing.

16. The apparatus of claim 1, wherein the puck further comprises one or more identification features.

17. The apparatus of claim 1, wherein the base of the puck further comprises one or more registration features.

18. (canceled)

19. A method of processing produce comprising:
taking an item of produce,
assigning said item of produce to an individual puck including a spike extending therefrom, by piercing said produce on said spike.

20. The method of claim 19, further comprising:
performing at least one further operation on said pierced produce, said operation reducing said produce.

21. (canceled)

22. The method of claim 19, wherein said produce is positioned on said spike such that a predetermined feature of said produce is aligned to a predetermined position relative to said puck.

23. A system comprising apparatus for detecting one or more anatomical features of an item of produce via a pair of cameras aligned on common axis, and
using said anatomical features to determine a natural axis of said produce, wherein said system employs the method of claim 19 to pierce said produce along said natural axis of said produce.

24. The system of claim 23, wherein the anatomical feature is one of a stem, calyx, blossom end, pedicel, tip, root of the produce.

25. The system of claim 24, further comprising apparatus for aligning said axis of the item of produce along a predetermined direction and at a predetermined position, such that the approximate location of a centroid of the item of produce is predicted.

26. The system of claim 25, further configured to pierce the item of produce such that the centroid is at a predetermined location.

27. The system of claim 26, comprising apparatus for sequentially rotating the item of produce about two substantially orthogonal axes, until said axis is aligned along a predetermined direction.

28. The system of claim 24, comprising apparatus for translating the item of produce, until said axis is aligned along a predetermined direction.

29-78. (canceled)
